(19) United States
(12) Patent Application Publication
(10) Pub. No.: US 2008/0077612 A1
(43) Pub. Date: Mar. 27, 2008

(54) Working with temporal data

(75) Inventors: Elana Zobin, Oakland, CA (US); Mary Kiyama, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bridgestream, San Francisco, CA (US)

(21) Appl. No.: 10/827,621

(22) Filed: Apr. 19, 2004

Related U.S. Application Data
(60) Provisional application No. 60/550,974, filed on Mar. 5, 2004.

(51) Int. Cl. G06F 17/00

(52) U.S. Cl. 707/103 R

(57) ABSTRACT

A database including a set of objects, each object being associated with a set of attributes; and a database including a set of objects, each object being associated with a set of attributes, each attribute being associated with a set of business rules for use or modification thereof. The database includes temporal data specifying life spans associated with one or more of those attributes, associated with one or more of those attributes, associated with one or more of those business rules, and/or associated with one or more rights to use or modify that database. Access to the attributes, application of those business rules, and/or whether the database provides access to use or modify data is responsive to at least some of those life spans including life spans for containing objects, for other versions of the attributes, business rules or rights with different life spans, or for some combination thereof.

### CROSS REFERENCE TO RELATED APPLICATION

This application claims priority of application Ser. No. 60/550,974 filed Mar. 5, 2004.

### BACKGROUND OF THE INVENTION

1. Field of the Invention

This invention relates to techniques capable of working with data that includes temporal aspects.

2. Related Art

An element that can be used in some previous relational databases is a “date relational object.” This type of object is associated with a date or dates. However, the temporal nature of this data is not fully accessible.

For example, date relational objects is such previous systems do not support multiple, non-contiguous life spans in the following ways:
When saving records to the database, only the lifespan of the object being saved is considered. If there are other lifespans of the same object (same primary key but effective in a completely exclusive timespans), those other lifespans may need to be adjusted.
When querying for contained objects (such as org_members of an organization) in the past or the future, such contained objects may not be contained by the lifespan of the Date Relational object being manipulated, but rather may be contained objects of some other lifespan of that organization object.
When trying to determine another lifespan of a Date Relational object, multiple and repetitive queries must be done, and the caller of the Date Relational API's can easily lose track of which lifespan is being manipulated.

### SUMMARY OF THE INVENTION

The invention provides techniques capable of working with temporal data that enables functionality lacking in previous systems.

For a first example, not intended to be limiting in any way, objects in an enterprise database can have attributes associated with those objects, which attributes have specified life spans, that is, which reflect for what time durations it was true (or it is planned to be true) that those attributes applied (or it is planned that they will apply) to those objects.

For a second example, not intended to be limiting in any way, an enterprise database can have business rules, which business rules have similar specified life spans.

For a third example, not intended to be limiting in any way, an enterprise database can have DRM (data rights management) rules, which DRM rules have similar specified life spans. These DRM rules can also have specified granularity, with the effect of having the ability to specify those DRM rules for a particular combination of person, relationship, attribute, and time view.

For a fourth example, not intended to be limiting in any way, an enterprise database can have service information associated with objects in the database, with the effect that the database can operate with temporal data, can present temporal views, and can maintain some records as in progress while maintaining other records as finalized.

Embodiments of the invention that enable these examples include a database including a set of objects, each object being associated with a set of attributes; and a database including a set of objects, each object being associated with a set of attributes, each attribute being associated with a set of business rules for use or modification thereof. The database includes temporal data specifying life spans associated with one or more of those attributes, associated with one or more of those attributes, associated with one or more of those business rules, and/or associated with one or more rights to use or modify that database. Access to the attributes, application of those business rules, and/or whether the database provides access to use or modify data is responsive to at least some of those life spans including life spans for containing objects, for other versions of the attributes, business rules or rights with different life spans, or for some combination thereof.

When working with information having temporal data, the inventive techniques maintain the consistency of the temporal data.
Modification of temporal data in a non-atomic process (such as for example a process requiring approval from more than one actor) can be performed using techniques for maintaining those modifications as provisional until they are committed. These techniques allow consistent modifications to proceed concurrently. These techniques also allow modifications to appear atomic to users of the database, even when those modifications are changes to something that was true in the past, or is planned to be true in the future.
Similarly, modification of objects and their attributes in the database causes any updates to be validated against other information maintained by the database, which themselves might reflect facts that were true in the past or are planned to be true in the future. Since validation of the change against temporal data already in the database can be made part of the atomicity of the change, the inventive techniques can assure that validations can be made consistent with both past business rules and future business rules before any changes are committed as final.
Concurrent modification of temporal data can be performed using locking techniques. These techniques allow the maximal opportunity for concurrent non-atomic operations, while ensuring against inconsistent modifications made in response to stale information. In one embodiment, each process, user or workgroup that attempts use objects including temporal data is (optimistically) given a lock on that object, with the expectation that most attempts to use that data will not involve any conflicts. Each such optimistic lock is recorded, so that when changes associated with one of those locks are to be committed, that process, user or workgroup is (pessimistically) given a lock on that object, with the effect that only one attempt to modify that object can be performed, and with the effect that each other attempt to modify that object will use the new version of the object.
Corrections of previously-entered data can themselves be given one or more attributes having temporal characteristics. These attributes allow auditing and other tracking of information having temporal characteristics, so as to indicate when errors or corrections were made, and by whom.
When temporal data is applied to objects that are themselves composed of sub-parts, the invention provides techniques for cross-affiliation of composite objects even when the underlying the database or other storage system does not have such capability. For one example, not intended to be limiting in any way, the invention includes techniques for constructing keys for cross-referencing objects, with the effect of being able to take advantage of object inheritance, and permitting object polymorphism, even when the parent objects are different. In one embodiment, these techniques include constructing a unique name for each particular object, and assigning that object particular its properties in response to its unique name. For one example, not intended to be limiting in anyway, a unique name for an individual person might differ from a unique name for a title (or position), but the properties accorded to individual persons might be much the same as those accorded to titles or positions.

After reading this application, those skilled in the art would recognize that the systems described herein provide an enabling technology, with the effect that heretofore advantageous features can be provided that heretofore were substantially infeasible.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE FIGURES

FIG. 1 shows a database structure in which objects are associated with a set of attributes, business rules, or rights, with the database including temporal data specifying life spans associated with one or more of those attributes, business rules, or rights.

FIG. 2 shows a method of using the database structure shown in FIG. 1.

### DESCRIPTION OF THE PREFERRED EMBODIMENT

### Definitions

The general meaning of each of these terms is intended to be illustrative and in no way limiting.
The terms “database” and “record” generally describe any technique by which information is maintained in memory or storage for later use. For one example, not intended to be limiting in any way, a database might include a relational database, the database having a set of tables, the tables each having a set of fields (of which some can be used as keys), and the tables having a set of records, each including information for at least some of the fields defined for that table. In alternative examples, a database might include an object-oriented database, a flat file structure, or another technique. In the context of the invention, there is no particular requirement that the database include a relational database, or that it must have specific records.
The phrase “temporal data” generally describes any information relating to a start time, end time, time duration, or time epoch, for information maintained in the database. In the context of the invention, this phrase is intended not to be equivalent to a mere timestamp, but is intended to refer to a time duration when an object existed or that object had a selected attribute. For one example, not intended to be limiting in any way, temporal data might include the time epoch during which a particular person was employed, or held a particular position in a company, or during which a particular rule was in effect for business operations. In the context of the invention, there is no particular requirement that particular items of temporal data have no gaps or overlap.
The phrase “life span” is used herein to refer to any span corresponding to a start time to an end time, a time duration, and/or a time epoch.
The phrase “attribute” generally describes any property of an object about which information is maintained in the database. In the context of the invention, an object in the database might refer to multiple records of a relational database, with the effect that an attribute might apply to a particular set of records or even to a particular set of objects. For one example, not intended to be limiting in anyway, an attribute of an object might include the surname of a particular person. In the context of the invention, there is no particular requirement that an attribute must have discrete values, only that whatever information about the attribute might be maintained in a format permitting distinction among a plurality of time epochs.
The phrase “process, user, or workgroup” or the like is intended to broadly encompass and entity, process or thing that can modify, access, or otherwise interact with a database, either directly or indirectly.

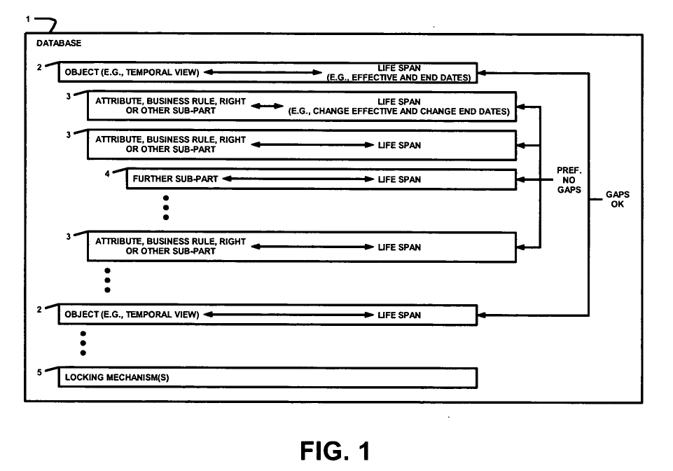

FIG. 1 shows a database structure in which objects are associated with a set of attributes, business rules, or rights, with the database including temporal data specifying life spans associated with one or more of those attributes, business rules, or rights.

Briefly, an embodiment of the database includes a set of objects, each object being associated with a set of attributes, or includes a set of objects, each object being associated with a set of attributes, each attribute being associated with a set of business rules for use or modification thereof. The database includes temporal data specifying life spans associated with one or more of those attributes, associated with one or more of those attributes, associated with one or more of those business rules, and/or associated with one or more rights to use or modify that database.

FIG. 1 shows database 1, for example a relational enterprise database or other type of database. The database in FIG. 1 includes objects 2. In one embodiment, not intended to be limiting in any way, objects 2 are “temporal views.”

Each of objects 2 preferably has temporal data specifying at least one life span associated therewith. In some embodiments, all of objects 2 are associated with such life spans. In other embodiments, some of objects 2 are not associated with such life spans. In a preferred embodiment, gaps between life spans for the objects are permissible, although this need not be the case.

The life spans of objects 2 can be defined by effective dates and end dates. Other techniques for specifying life spans for objects 2 can be used.

Objects 2 in FIG. 1 can include one or more attributes, business rules, rights to use or modify database 1, or other sub-parts 3. These can, but do not necessarily have, further sub-parts.

Each of sub-parts 3 preferably has temporal data specifying at least one life span associated therewith. In some embodiments, all of sub-parts 3 are associated with such life spans. In other embodiments, some of sub-parts 3 are not associated with such life spans. In a preferred embodiment, gaps between life spans for the sub-parts are not permissible, although this need not be the case.

In one embodiment, each attribute, business rule, right or other sub-part 3 in one of objects 2 is a different version of that attribute, business rule, right or other sub-part 3 for a different life span. For example, not intended to be limiting in any way, sub-parts in one of the objects could include an attribute specifying a name, address, phone number and access rights for a person. Each sub-part with which a life-span was associated could include a different name, address, phone number and/or access right(s) corresponding to different life spans. Alternatively, each of the name, address, phone number and access rights in this example could be considered to be a separate sub-part.

The life spans of sub-parts 3 can be defined by change effective dates and change end dates. These dates are referred to as “change dates” because they represent a time at which a sub-part changes to another version of that sub-part based on the dates. Other techniques for specifying life spans for sub-parts 3 can be used.

In a preferred embodiment, access to the attributes, application of those business rules, and/or whether the database provides access to use or modify data is responsive to at least some of those life spans including life spans for containing objects 2, for other versions of the attributes, business rules or rights 3 with different life spans, or for some combination thereof.

Database 1 also preferably includes locking mechanism(s) 5. In a preferred embodiment, these include optimistic locks for accessing data and pessimistic locks for committing changes to data in the database.

In one embodiment, each process, user or workgroup that attempts access objects including temporal data is (optimistically) given a lock on that object, with the expectation that most attempts to use that data will not involve any conflicts. Each such optimistic lock is recorded, so that when changes associated with one of those locks are to be committed, that process or user or workgroup can be (pessimistically) given a lock on that object, with the effect that only one attempt to modify that object can be performed, and with the effect that each other attempt to modify that object will use the new version of the object.

Method of Operation

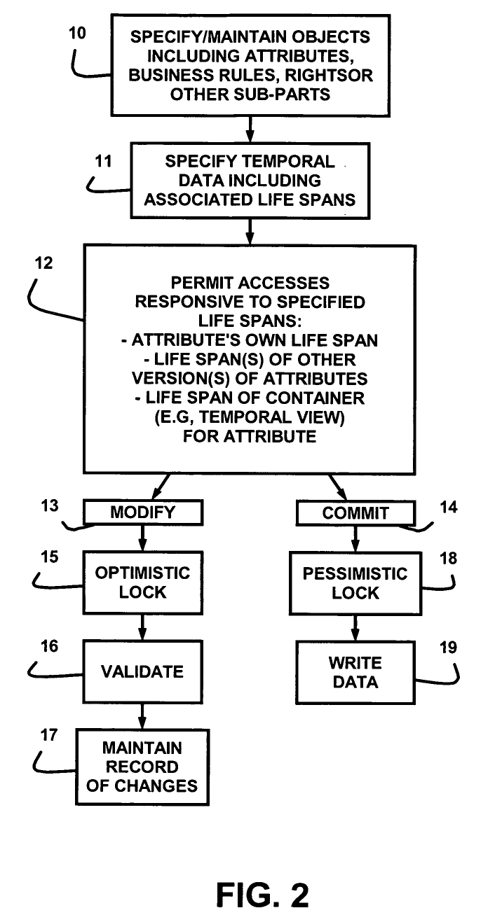

Steps for one possible embodiment of the invention are discussed below with reference to FIG. 2. Preferably, the steps are executed in the order shown. However, the invention also encompasses embodiments in which the steps are executed in different orders, where possible, and in different arrangements, for example in parallel.

FIG. 2 shows a method of using the database structure shown in FIG. 1.

In step 10, a set of objects are specified and maintained in a database such as database 1 in FIG. 1. Each such object preferably is associated with a set of attributes, each of which can be or can be further associated with a set of business rules or rights for use or modification thereof.

Temporal data for the objects are specified in step 11. This temporal data preferably specifies life spans associated with one or more of those attributes, associated with one or more of those attributes, associated with one or more of those business rules, and/or associated with one or more rights to use or modify that database.

Accesses to the database are permitted in step 12. Accesses can be responsive to at least some of the life spans. Accesses to sub-parts (e.g., attributes, business rules, right or other sub-parts) can be responsive to that sub-part's life span, to the life span for the object that contains the sub-part, to life spans of other versions of the sub-part in that object, or in other ways. Accesses that are not responsive to life spans also are permitted.

Accesses to the data can include, but are not limited to, modification and commitment of modifications to changes. Thus, FIG. 2 shows modify block 13 and commit block 14.

Modification of sub-parts such as attributes, business rules, rights, and temporal data can be implemented in using non-atomic processes. (For some modifications, coding of inherently atomic process may not be feasible.) If such modification uses a non-atomic process, that modification preferably is performed using techniques for maintaining those modifications as provisional until those modifications are committed, whereby consistent modifications can be performed concurrently. Optimistic lock step 15 is such a technique.

In the preferred embodiment, an optimistic lock is recorded but does not preventing other processes, users or workgroups from attempting to use said object. Thus, consistent changes can be made by different processes, users or workgroups without running afoul of the lock. Inconsistent changes are handled when the changes are committed. Alternatively, other locking techniques can be used.

In step 16, each modification is validated against other information maintained by the database. For example, each modification can be checked for consistency with the temporal data in the database. Consistency could require preventing gaps between life spans within each temporal view, while permitting gaps between life spans among different temporal views. Other types of consistent could be checked.

A record of changes to said objects can be maintained in the database in step 17. Preferably, temporal data is associated with these changes. This step facilitates tracking of changes to the database.

The foregoing steps involved in modifying data in the database facilitate various applications of the database, some of which are outlined below. Not all embodiments of the invention will facilitate some or all of these applications. Likewise, some embodiments of the invention will facilitate other applications.
For a first example, not intended to be limiting in any way, objects in an enterprise database can have attributes associated with those objects, which attributes have specified life spans, that is, which reflect for what time durations it was true (or it is planned to be true) that those attributes applied (or it is planned that they will apply) to those objects.
For a second example, not intended to be limiting in any way, an enterprise database can have business rules, which business rules have similar specified life spans.
For a third example, not intended to be limiting in any way, an enterprise database can have DRM (data rights management) rules, which DRM rules have similar specified life spans. These DRM rules can also have specified granularity, with the effect of having the ability to specify those DRM rules for a particular combination of person, relationship, attribute, and time view.
For a fourth example, not intended to be limiting in any way, an enterprise database can have service information associated with objects in the database, with the effect that the database can operate with temporal data, can present temporal views, and can maintain some records as in progress while maintaining other records as finalized.

Turning to steps following commit block 14, a pessimistic lock preferably is used in step 18 for the process of committing a change or changes to the database. In the preferred embodiment, a pessimistic lock prevents other processes, users or workgroups from attempting to commit inconsistent changes to an object. Other locking techniques can be used.

In one embodiment, this pessimistic lock interacts with the optimistic lock in step 15 in the following manner: Each process, user or workgroup that attempts access objects including temporal data is (optimistically) given a lock on that object, with the expectation that most attempts to use that data will not involve any conflicts. Each such optimistic lock is recorded, so that when changes associated with one of those locks are to be committed, that process or user or workgroup can be (pessimistically) given a lock on that object, with the effect that only one attempt to modify that object can be performed, and with the effect that each other attempt to modify that object will use the new version of the object.

If a pessimistic lock is successful, changes are written or otherwise actually committed to the database in step 19.

### IMPLEMENTATION EXAMPLE

The following implementation example shows technical details of one possible embodiment of the invention. All reasonable generalizations of techniques shown in this implementation example are within the scope and spirit of the invention, and would be workable, without further invention or undue experimentation.

### 1 Example Implementation

1.1 Record Status

The record status of a Date Relational record is used to preserve the history of each transaction that is performed on Date Relational objects. The following record statuses are introduced in this proposed solution:

/** Indicates that the record was saved in a workflow, and once finalized
* to the database, is no longer a valid record.
*/
public static final String STATUS_INVALID = “INV”;
/** Indicates that the record was at one time a final record, but has
been modified
* by an attribute change. This status is a historical record that is kept for
* maintaining a history of changes.
*/
public static final String STATUS_HISTORICAL = “H”;
/** Indicates that the record has been replaced (removed) by another
* record. This will happen during corrections. (formerly
STATUS_REMOVED)
*/
public static final String STATUS_REPLACED = “R”;
/** Indicates that the record is currently saved within a workflow, as
* a removed (replaced) record in a correction.
* (formerly STATUS_SAVED_REMOVED)
*/
public static final String STATUS_SAVED_REPLACED = “SR”;

The following record statuses are already used in the Data Relational model:

/** Indicates that the record is a final record.
*/
public static final String STATUS_FINAL = “F”;
/** Indicates that the record is currently saved within a workflow, but
* not yet finalized, and therefore not yet visible to other workflows.
*/
public static final String STATUS_SAVED = “S”;
/** Indicates that the record is currently saved (as deleted) within a
workflow, but
* not yet finalized, and therefore not yet visible to other workflows.
*/
public static final String STATUS_SAVED_DELETE = “SD”;

### 1.1.1 Correction Records

The caller may specify if a transaction is considered a correction. When performing a correction, the same data is preserved as is for historical records; however, a different record_status is used to differentiate between a historical record and a corrected record.

The caller specifies if a change is a correction by using the correction_mode parameter in the API.

### 1.1.2 Workflow Records Table

The ATTR_WF_RECORDS table holds information about record changes through the life of the workflow.

ATTR_WF_RECORDS

| | | Is | |
|---|---|---|---|
| Field Name | Type | NULL | Description |
| WORK_ID | NUMBER(30) | No | The workflow id. |
| RECORD_ID | NUMBER(30) | No | The record_id of the final record |
| | | | that is being modified by this |
| | | | workflow. |
| | | | If −1, indicates the workflow (in- |
| | | | progress) record is a new record |
| | | | created in this workflow, and has no |
| | | | associated final record. |
| WF_RECORD_ID | NUMBER(30) | No | The record_id of the workflow (in- |
| | | | progress) record. |
| | | | If −1, indicates the final record is |
| | | | being removed from the system, and |
| | | | has no associated in-progress |
| | | | record. |
| IS_CORRECTION | VARCHAR(1) | No | ‘Y’ - indicates the final record is |
| | | | being corrected by the caller. |
| | | | ‘N’ - default |

The ATTR_WF_RECORDS table is used for the following:
1. Maintains the link between a final record, and the associated in-progress record throughout the life of the workflow. The in-progress record_id may change during the workflow, as the record is being modified, overwritten or corrected. The date fields cannot be used to determine this linkage, as records could be “moved” in time from their original lifespan.
2. Indicates if a workflow record is a new AttributeSet introduced in this workflow (record_id=−1), or if a final record is being removed from the system (wf_record_id=−1).
3. Stores the correction mode of the transaction for the specific change. When the changes are finalized, this information is used to change the record_status of the final record to either STATUS_REPLACED (for correction) or STATUS_HISTORICAL.
   The entries to this table are inserted/updated on the save( ) method of the ENDRBaseObject class.
   1.2 Temporal Representation
   Each logical entity or relationship (wherefrom referred as object) in XRM is treated as a single object with multiple, potentially non-adjacent life spans. Within each lifespan of the object multiple dated AttributeSets may exists.
   When an object in XRM is accessed it is accessed in whole including all of its available life spans eliminating the need for the API user to know beforehand the time objects existed. The API user can interrogate the object itself for its valid life time frames and attributes that apply.
   Each XRM object is represented by ENDRBaseObject based object. Each such object contains one or more object life spans, called TemporalView. Each TemporalView contains one or more AttributeSets, each with its own lifespan.
   An AttributeSet contains the following data items:
Change effective date
Change end date
Record status
Record id number
Is-modified flag
Is-new flag
Is-overwritten flag
Is-correction flag
   A TemporalView object contains the following data items:
Effective date
End date
Collection of AttributeSets
   The following data integrity rules are enforced with regard to temporal objects:
1. A TemporalView contains one or more AttributeSets, sorted by change effective date. If there is exactly one AttributeSet, its change effective date should be the same as the effective date of the containing TemporalView, and its change end date should be the same as the end date of the containing TemporalView. If there are more than one AttributeSets, the change effective date of the first AttributeSet should be the same as the effective date of the containing TemporalView, and the change end date of the last AttributeSet should be the same as the end date of the containing TemporalView. All AttributeSets within a TemporalView should be contiguous in time, i.e. the change end date of a given AttributeSet should be exactly one second prior to the change effective date of the next AttributeSet, if any.
2. A Date Relational object contains a collection of TemporalViews, sorted by effective date. The lifespan of any TemporalView should not overlap the lifespan of any other TemporalView in the containing Date Relational object, but is not necessarily contiguous with the lifespans of other TemporalViews. Thus, there may be temporal lacunae between TemporalViews.
   The following processing rules apply when temporal objects are manipulated in memory:
1. If an AttributeSet is changed, but not removed, its is_modified flag is set to true.
2. If an AttributeSet is removed in the process of modification to its containing TemporalView, its is_overwritten flag is set to true. This rule would apply, for example, when the lifespan of the containing TemporalView is changed so that it no longer overlaps the lifespan of the AttributeSet.
3. When a new AttributeSet is created, its record status is set to ‘U’, its is_modified flag is set to true, its is_new flag is set to true, and its record id number is set to minus one.
4. When an AttributeSet is created, modified, or removed while correction mode is turned on, its is_correction flag is set to true.
   This document outlines the expected behavior of the Date Relational engine for the following APIs:
1. AttributeSets
   a. Change AttributeSet
   b. Insert AttributeSet
   c. Remove AttributeSet
   d. Change AttributeSet Timespan
2. TemporalView
   a. Add TemporalView
   b. Remove TemporalView
   c. Change TemporalView Lifespan

### 1.2.1 AttributeSet

AttributeSets maintain the attribute information for a specific time period within a TemporalView lifespan. The time period of the AttributeSet is determined by the CHG_EFFECTIVE_DATE and CHG_END_DATE columns of the table.

1.2.1.1 Change AttributeSet

When changing an AttributeSet, the caller creates a new AttributeSet by specifying a chg_effective_date. The AttributeSet that exists on that chg_effective_date will be copied into the new AttributeSet, thus retaining all attribute information from the existing AttributeSet. The caller can then modify attributes on the newly created AttributeSet, with the exception of dates. Dates (change or lifespan) cannot be changed explicitly using this API, other than when the chg_effective_date is set when the AttributeSet is first created. The chg_end_date of the previously existing AttributeSet will automatically adjust.

This API should be used when it is desired to have the new AttributeSet inherit most of the attributes of the original AttributeSet.

The following will happen when changing an AttributeSet:

1. Caller creates a new AttributeSet, specifying a chg_effective_date. Whichever AttributeSet already exists on that chg_effective_date will used to create the new AttributeSet.
2. The new AttributeSet will retain the original AttributeSet's data, with the exception of the chg_effective_date.
3. The caller can make any modifications to the attributes of the new AttributeSet, with the exception of date changes.
4. When storing the data to the database, the chg_end_date of the original AttributeSet will be adjusted to one second before the new AttributeSet's chg_effective_date.
   Interface:

TemporalView class:

/**
Finds the AttributeSet that exists on chg_effective_date. Creates a new
AttributeSet object that is a copy of the existing AttributeSet, with the
exception of the
chg_effective_date (which will be passed in value).
@return AttributeSet the newly created AttributeSet
@param correction_mode true if this change should be considered
a correction.
Default is false
@throws ENException if chg_effective_date is out of range of this
Temporal View
object
*/

public AttributeSet changeAttributeSet(UTTimestamp chg_effective_date); public AttributeSet changeAttributeSet(UTTimestamp chg_effective_date, boolean correction_mode);

### Example 1

### Change Attributeset (Simple)

Rachel's PERSON record exists in the system from 01/01/01 until ∞. Her last name is Smith, and her phone number is 111.

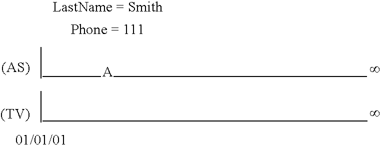

| | | | | | Chg- | | | Rec- |
|---|---|---|---|---|---|---|---|---|
| | Last | | Eff | End | Eff | ChgEnd | Record | ord |
| ID | Name | Phone | Date | Date | Date | Date | Status | ID |
| 27 | Smith | 111 | Jan. 1, | ∞ | Jan. 1, | ∞ | F | A |
| | | | 2001 | | 2001 | | | |

Rachel changes her last name to Jones, and her phone to 222 on 05/01/01. This transaction creates record B for the new AttributeSet, changes record A to a historical record, and creates record C with the modified chg_end_date of that AttributeSet.

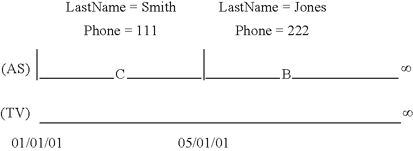

Workflow Records

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | F | A |
| 27 | Jones | 222 | Jan. 01, 2001 | ∞ | May 01, 2001 | ∞ | S | B′ |
| 27 | Smith | 111 | Jan. 01, 2001 | ∞ | Jan. 01, 2001 | Apr. 30, 2001 | S | C′ |

ATTR_WF_RECORDS

| RecordID | WFRecordID | IsCorrection |
|---|---|---|
| A | C′ | N |
| −1 | B | N |

Finalized Records w/in Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | [symbol] H | A |
| 27 | Jones | 222 | Jan. 01, 2001 | ∞ | May 01, 2001 | ∞ | [symbol] INV | B′ |
| 27 | Smith | 111 | Jan. 01, 2001 | ∞ | Jan. 01, 2001 | Apr. 30, 2001 | [symbol] INV | C′ |
| 27 | Jones | 222 | Jan. 01, 2001 | ∞ | May 01, 2001 | ∞ | F | B |
| 27 | Smith | 111 | Jan. 01, 2001 | ∞ | Jan. 01, 2001 | Apr. 30, 2001 | F | C |

Finalized Records w/o Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | [symbol] H | A |
| 27 | Jones | 222 | Jan. 01, 2001 | ∞ | May 01, 2001 | ∞ | F | B |
| 27 | Smith | 111 | Jan. 01, 2001 | ∞ | Jan. 01, 2001 | Apr. 30, 2001 | F | C |

### Example 2

### Change AttributeSet (Split)

Continuing from the previous example, Rachel changes her phone number to 999 on 03/01/01. This transaction creates record D for the new AttributeSet, changes record C to a historical record, and creates record E with the modified chg_end_date.

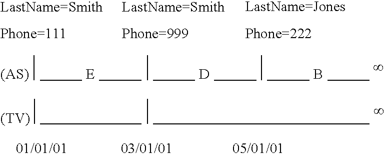

Workflow Records

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | [symbol] H | A |
| 27 | Jones | 222 | Jan. 01, 2001 | ∞ | May 01, 2001 | ∞ | [symbol] INV | B′ |
| 27 | Smith | 111 | Jan. 01, 2001 | ∞ | Jan. 01, 2001 | Apr. 30, 2001 | [symbol] INV | C′ |
| 27 | Jones | 222 | Jan. 01, 2001 | ∞ | May 01, 2001 | ∞ | F | B |
| 27 | Smith | 111 | Jan. 01, 2001 | ∞ | Jan. 01, 2001 | Apr. 30, 2001 | F | C |
| 27 | Smith | 999 | Jan. 01, 2001 | ∞ | Mar. 01, 2001 | Apr. 30, 2001 | S | D′ |
| 27 | Smith | 111 | Jan. 01, 2001 | ∞ | Jan. 01, 2001 | Feb. 28, 2001 | S | E′ |

ATTR_WF_RECORDS

| RecordID | WFRecordID | IsCorrection |
|---|---|---|
| C | E′ | N |
| −I | D′ | N |

Finalized Records w/in Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | z,801 H | A |
| 27 | Jones | 222 | Jan. 01, 2001 | ∞ | May 01, 2001 | ∞ | z,803 INV | B′ |
| 27 | Smith | 111 | Jan. 01, 2001 | ∞ | Jan. 01, 2001 | Apr. 30, 2001 | z,803 INV | C′ |
| 27 | Jones | 222 | Jan. 01, 2001 | ∞ | May 01, 2001 | ∞ | F | B |
| 27 | Smith | 111 | Jan. 01, 2001 | ∞ | Jan. 01, 2001 | Apr. 30, 2001 | z,801 H | C |
| 27 | Smith | 999 | Jan. 01, 2001 | ∞ | Mar. 01, 2001 | Apr. 30, 2001 | z,803 INV | D′ |
| 27 | Smith | 111 | Jan. 01, 2001 | ∞ | Jan. 01, 2001 | Feb. 28, 2001 | z,803 INV | E′ |
| 27 | Smith | 999 | Jan. 01, 2001 | ∞ | Mar. 01, 2001 | Apr. 30, 2001 | F | D |
| 27 | Smith | 111 | Jan. 01, 2001 | ∞ | Jan. 01, 2001 | Feb. 28, 2001 | F | E |

Finalized Records w/o Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | z,801 H | A |
| 27 | Jones | 222 | Jan. 01, 2001 | ∞ | May 01, 2001 | ∞ | F | B |
| 27 | Smith | 111 | Jan. 01, 2001 | ∞ | Jan. 01, 2001 | Apr. 30, 2001 | z,801 H | C |
| 27 | Smith | 999 | Jan. 01, 2001 | ∞ | Mar. 01, 2001 | Apr. 30, 2001 | F | D |
| 27 | Smith | 111 | Jan. 01, 2001 | ∞ | Jan. 01, 2001 | Feb. 28, 2001 | F | E |

1.2.1.2 Insert AttributeSet
When inserting an AttributeSet, the caller creates a new AttributeSet by specifying the chg_effective_date and chg_end_date. The effective_date and end_date fields will be set automatically according to the TemporalView. The caller should set the values of all required attributes, and any optional attributes. Any adjacent AttributeSets within that TemporalView will have the change dates automatically adjusted. The caller may specify whether overwriting AttributeSets are allowed, in the event where the insert will completely contain one or more existing AttributeSets.
The following will happen when inserting an AttributeSet:
1. The caller creates a new AttributeSet, and specifies the chg_effective_date and chg_end_date. The caller is returned a new AttributeSet object, that will have the change dates as well as the effective_date and end_date set.
2. The caller sets the attribute fields to the desired values.
3. When storing to the database, the change dates of any adjacent records are automatically adjusted, and any AttributeSets that are required to maintain continuity, are automatically created.
   Interface:

TemporalView class:

/*
Creates a new AttributeSet object, with the chg_effective_date and
chg_end_date values set as passed in, and the effective_date
and end_date set
according to the lifespan of this TemporalView. The non-pk attributes
should be
explicitly set as desired.
@param overwrite boolean true if other Attribute Sets that are
completely contained
by this new AttributeSet may be overwritten.
@param correction_mode true if this change should be considered a
correction.
Default is false
@return AttributeSet the newly created AttributeSet
@throws ENException if the change dates are not within the lifespan
of this
Temporal View
*/
public AttributeSet insertAttributeSet(UTTimestamp chg_effective_date,
UTTimestamp chg_end_date, boolean overwrite);
public AttributeSet insertAttributeSet(UTTimestamp chg_effective_date,
UTTimestamp chg_end_date, boolean overwrite, boolean
correction_mode);

### Example 1

### Insert AttributeSet (Simple)

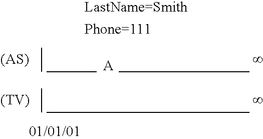

| | | | | | | | | Rec- |
|---|---|---|---|---|---|---|---|---|
| | Last | | Eff | End | ChgEff | ChgEnd | Record | ord |
| ID | Name | Phone | Date | Date | Date | Date | Status | ID |
| 27 | Smith | 111 | Jan. 1, | ∞ | Jan. 1, | ∞ | F | A |
| | | | 2001 | | 2001 | | | |

Rachel changes her last name to Jones, and her phone to 222 on 08/01/01. This transaction creates record B for the new AttributeSet, changes record A to a historical record, and creates record C with the modified chg_end_date of that AttributeSet.

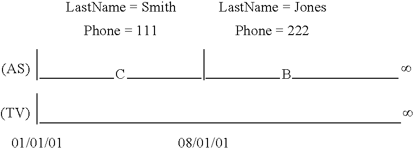

Workflow Records

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | F | A |
| 27 | Jones | 222 | Jan. 01, 2001 | ∞ | Aug. 01, 2001 | ∞ | S | B′ |
| 27 | Smith | 111 | Jan. 01, 2001 | ∞ | Jan. 01, 2001 | Jul. 31, 2001 | S | C′ |

ATTR_WF_RECORDS

| RecordID | WFRecordID | IsCorrection |
|---|---|---|
| A | C′ | N |
| −I | B′ | N |

Finalized Records w/in Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | z,801 H | A |
| 27 | Jones | 222 | Jan. 01, 2001 | ∞ | Aug. 01, 2001 | ∞ | z,803 INV | B′ |
| 27 | Smith | 111 | Jan. 01, 2001 | ∞ | Jan. 01, 2001 | Jul. 31, 2001 | z,803 INV | C′ |
| 27 | Jones | 222 | Jan. 01, 2001 | ∞ | Aug. 01, 2001 | ∞ | F | B |
| 27 | Smith | 111 | Jan. 01, 2001 | ∞ | Jan. 01, 2001 | Jul. 31, 2001 | F | C |

Finalized Records w/o Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | z,801 H | A |
| 27 | Jones | 222 | Jan. 01, 2001 | ∞ | Aug. 01, 2001 | ∞ | F | B |
| 27 | Smith | 111 | Jan. 01, 2001 | ∞ | Jan. 01, 2001 | Jul. 31, 2001 | F | C |

### Example 2

### Insert AttributeSet (Split)

Continuing from the previous example, Rachel inserts a new AttributeSet, specifying chg_effective_date of 03/01/01 and chg_end_date of 03/31/01. She specifies her last name to be White, and her number to be 999. The

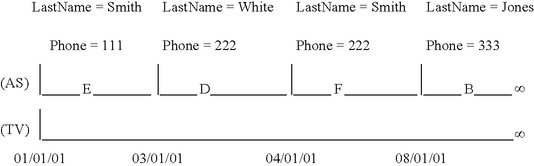

Workflow Records

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | z,801 H | A |
| 27 | Jones | 222 | Jan. 01, 2001 | ∞ | Aug. 01, 2001 | ∞ | z,803 INV | B′ |
| 27 | Smith | 111 | Jan. 01, 2001 | ∞ | Jan. 01, 2001 | Jul. 31, 2001 | z,803 INV | C′ |
| 27 | Jones | 222 | Jan. 01, 2001 | ∞ | Aug. 01, 2001 | ∞ | F | B |
| 27 | Smith | 111 | Jan. 01, 2001 | ∞ | Jan. 01, 2001 | Jul. 31, 2001 | F | C |
| 27 | White | 999 | Jan. 01, 2001 | ∞ | Mar. 01, 2001 | Mar. 31, 2001 | S | D′ |
| 27 | Smith | 111 | Jan. 01, 2001 | ∞ | Jan. 01, 2001 | Feb. 28, 2001 | S | E′ |
| 27 | Smith | 111 | Jan. 01, 2001 | ∞ | Apr. 01, 2001 | Jul. 31, 2001 | S | F′ |

ATTR_WF_RECORDS

| RecordID | WFRecordID | IsCorrection |
|---|---|---|
| C | E′ | N |
| −I | D′ | N |
| −1 | F′ | N |

Finalized Records w/in Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | [symbol] H | A |
| 27 | Jones | 222 | Jan. 01, 2001 | ∞ | Aug. 01, 2001 | ∞ | [symbol] INV | B′ |
| 27 | Smith | 111 | Jan. 01, 2001 | ∞ | Jan. 01, 2001 | Jul. 31, 2001 | [symbol] INV | C′ |
| 27 | Jones | 222 | Jan. 01, 2001 | ∞ | Aug. 01, 2001 | ∞ | F | B |
| 27 | Smith | 111 | Jan. 01, 2001 | ∞ | Jan. 01, 2001 | Jul. 31, 2001 | [symbol] H | C |
| 27 | White | 999 | Jan. 01, 2001 | ∞ | Mar. 01, 2001 | Mar. 31, 2001 | [symbol] INV | D′ |
| 27 | Smith | 111 | Jan. 01, 2001 | ∞ | Jan. 01, 2001 | Feb. 28, 2001 | [symbol] INV | E′ |
| 27 | Smith | 111 | Jan. 01, 2001 | ∞ | Apr. 01, 2001 | Jul. 31, 2001 | [symbol] INV | F′ |
| 27 | White | 999 | Jan. 01, 2001 | ∞ | Mar. 01, 2001 | Mar. 31, 2001 | F | D |
| 27 | Smith | 111 | Jan. 01, 2001 | ∞ | Jan. 01, 2001 | Feb. 28, 2001 | F | E |
| 27 | Smith | 111 | Jan. 01, 2001 | ∞ | Apr. 01, 2001 | Jul. 31, 2001 | F | F |

Finalized Records w/o Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | ∞ | [symbol] H | A |
| 27 | Jones | 222 | Jan. 01, 2001 | ∞ | Aug. 01, 2001 | ∞ | F | B |
| 27 | Smith | 111 | Jan. 01, 2001 | ∞ | Jan. 01, 2001 | Jul. 31, 2001 | [symbol] H | C |
| 27 | White | 999 | Jan. 01, 2001 | ∞ | Mar. 01, 2001 | Mar. 31, 2001 | F | D |
| 27 | Smith | 111 | Jan. 01, 2001 | ∞ | Jan. 01, 2001 | Feb. 28, 2001 | F | E |
| 27 | Smith | 111 | Jan. 01, 2001 | ∞ | Apr. 01, 2001 | Jul. 31, 2001 | F | F |

### Example 3

### Insert AttributeSet (Overlap)—with Correction

The following AttributeSets exist for Rachel's PERSON entity.

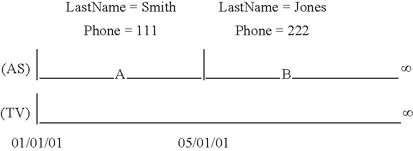

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 1, 2001 | ∞ | Jan. 1, 2001 | Apr. 30, 2001 | F | A |
| 27 | Jones | 222 | Jan. 1, 2001 | ∞ | May 1, 2001 | ∞ | F | B |

Rachel inserts a new AttributeSet, specifying chg_effective_date of 03/01/01 and chg_end_date of 06/30/01. The correction mode is set to true. She specifies her last name to be Brown, and her number to be 999. This transaction will create record D for the new AttributeSet, changes records A and B to historical records, and creates records D and E with the change date modifications.

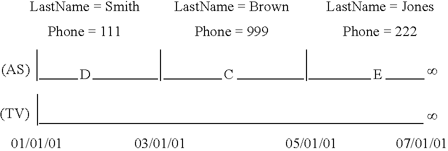

Workflow Records

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | Apr. 30, 2001 | F | A |
| 27 | Jones | 222 | Jan. 01, 2001 | ∞ | May 01, 2001 | ∞ | F | B |
| 27 | Brown | 999 | Jan. 01, 2001 | ∞ | Mar. 01, 2001 | Jun. 30, 2001 | S | C′ |
| 27 | Smith | 111 | Jan. 01, 2001 | ∞ | Jan. 01, 2001 | Feb. 28, 2001 | S | D′ |
| 27 | Jones | 222 | Jan. 01, 2001 | ∞ | Jul. 01, 2001 | ∞ | S | E′ |

ATTR_WF_RECORDS

| RecordID | WFRecordID | IsCorrection |
|---|---|---|
| A | D′ | Y |
| B | E′ | Y |
| −1 | C′ | N |

Finalized Records w/in Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | Apr. 30, 2001 | [symbol] R | A |
| 27 | Jones | 222 | Jan. 01, 2001 | ∞ | May 01, 2001 | ∞ | [symbol] R | B |
| 27 | Brown | 999 | Jan. 01, 2001 | ∞ | Mar. 01, 2001 | Jun. 30, 2001 | [symbol] INV | C′ |
| 27 | Smith | 111 | Jan. 01, 2001 | ∞ | Jan. 01, 2001 | Feb. 28, 2001 | [symbol] INV | D′ |
| 27 | Jones | 222 | Jan. 01, 2001 | ∞ | Jul. 01, 2001 | ∞ | [symbol] INV | E′ |
| 27 | Brown | 999 | Jan. 01, 2001 | ∞ | Mar. 01, 2001 | Jun. 30, 2001 | F | C |
| 27 | Smith | 111 | Jan. 01, 2001 | ∞ | Jan. 01, 2001 | Feb. 28, 2001 | F | D |
| 27 | Jones | 222 | Jan. 01, 2001 | ∞ | Jul. 01, 2001 | ∞ | F | E |

Finalized Records w/o Workflow

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | Apr. 30, 2001 | [symbol] R | A |
| 27 | Jones | 222 | Jan. 01, 2001 | ∞ | May 01, 2001 | ∞ | [symbol] R | B |
| 27 | Brown | 999 | Jan. 01, 2001 | ∞ | Mar. 01, 2001 | Jun. 30, 2001 | F | C |
| 27 | Smith | 111 | Jan. 01, 2001 | ∞ | Jan. 01, 2001 | Feb. 28, 2001 | F | D |
| 27 | Jones | 222 | Jan. 01, 2001 | ∞ | Jul. 01, 2001 | ∞ | F | E |

### Example 4

### Insert AttributeSet (Overwrite)

The following AttributeSets exist for Rachel's PERSON entity.

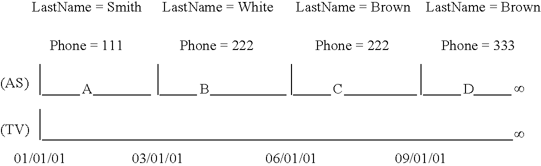

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 1, 2001 | ∞ | Jan. 1, 2001 | Feb. 28, 2001 | F | A |
| 27 | White | 222 | Jan. 1, 2001 | ∞ | Mar. 1, 2001 | May 31, 2001 | F | B |
| 27 | Brown | 222 | Jan. 1, 2001 | ∞ | Jun. 1, 2001 | Aug. 31, 2001 | F | C |
| 27 | Brown | 333 | Jan. 1, 2001 | ∞ | Sep. 1, 2001 | ∞ | F | D |

Rachel inserts a new AttributeSet specifying chg_effective_date 02/01/01 and chg_end_date 07/31/01. She specifies her LastName=Purple and Phone=999. She specifies to allow for overwrites.

Record B is completely overwritten. Record G is created for the new AttributeSet. Record A is becomes a historical record, and record E is created with the modified chg_end_date. Record C becomes a historical record, and record F is created with the modified chg_effective_date.

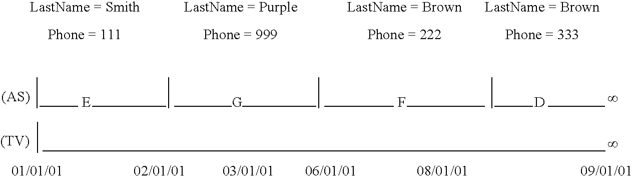

Workflow Records

| | Last | | Eff | End | ChgEff | ChgEnd | Record | Record |
|---|---|---|---|---|---|---|---|---|
| ID | Name | Phone | Date | Date | Date | Date | Status | ID |
| 27 | Smith | 111 | Jan. 01, 2001 | ∞ | Jan. 01, 2001 | Feb. 28, 2001 | F | A |
| 27 | White | 222 | Jan. 01, 2001 | ∞ | Mar. 01, 2001 | May 31, 2001 | F | B |
| 27 | Brown | 222 | Jan. 01, 2001 | ∞ | Jun. 01, 2001 | Aug. 31, 2001 | F | C |
| 27 | Brown | 333 | Jan. 01, 2001 | ∞ | Sep. 01, 2001 | ∞ | F | D |
| 27 | Smith | 111 | Jan. 01, 2001 | ∞ | Jan. 01, 2001 | Jan. 31, 2001 | S | E′ |
| 27 | Brown | 222 | Jan. 01, 2001 | ∞ | Aug. 01, 2001 | Aug. 31, 2001 | S | F′ |
| 27 | Purple | 999 | Jan. 01, 2001 | ∞ | Feb. 01, 2001 | Jul. 31, 2001 | S | G′ |

ATTR_WF_RECORDS

| RecordID | WFRecordID | IsCorrection |
|---|---|---|
| A | E′ | N |
| B | −1 | N |
| C | F′ | N |
| −1 | G′ | N |

Finalized Records w/in Workflow

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 01, 2001 | ∞ | Jan. 01, 2001 | Feb. 28, 2001 | [symbol] H | A |
| 27 | White | 222 | Jan. 01, 2001 | ∞ | Mar. 01, 2001 | May 31, 2001 | [symbol] H | B |
| 27 | Brown | 222 | Jan. 01, 2001 | ∞ | Jun. 01, 2001 | Aug. 31, 2001 | [symbol] H | C |
| 27 | Brown | 333 | Jan. 01, 2001 | ∞ | Sep. 01, 2001 | ∞ | F | D |
| 27 | Smith | 111 | Jan. 01, 2001 | ∞ | Jan. 01, 2001 | Jan. 31, 2001 | [symbol] INV | E′ |
| 27 | Brown | 222 | Jan. 01, 2001 | ∞ | Aug. 01, 2001 | Aug. 31, 2001 | [symbol] INV | F′ |
| 27 | Purple | 999 | Jan. 01, 2001 | ∞ | Feb. 01, 2001 | Jul. 31, 2001 | [symbol] INV | G′ |
| 27 | Smith | 111 | Jan. 01, 2001 | ∞ | Jan. 01, 2001 | Jan. 31, 2001 | F | E |
| 27 | Brown | 222 | Jan. 01, 2001 | ∞ | Aug. 01, 2001 | Aug. 31, 2001 | F | F |
| 27 | Purple | 999 | Jan. 01, 2001 | ∞ | Feb. 01, 2001 | Jul. 31, 2001 | F | G |

Finalized Records w/o Workflow

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 01, 2001 | ∞ | Jan. 01, 2001 | Feb. 28, 2001 | [symbol] H | A |
| 27 | White | 222 | Jan. 01, 2001 | ∞ | Mar. 01, 2001 | May 31, 2001 | [symbol] H | B |
| 27 | Brown | 222 | Jan. 01, 2001 | ∞ | Jun. 01, 2001 | Aug. 31, 2001 | [symbol] H | C |
| 27 | Brown | 333 | Jan. 01, 2001 | ∞ | Sep. 01, 2001 | ∞ | F | D |
| 27 | Smith | 111 | Jan. 01, 2001 | ∞ | Jan. 01, 2001 | Jan. 31, 2001 | F | E |
| 27 | Brown | 222 | Jan. 01, 2001 | ∞ | Aug. 01, 2001 | Aug. 31, 2001 | F | F |
| 27 | Purple | 999 | Jan. 01, 2001 | ∞ | Feb. 01, 2001 | Jul. 31, 2001 | F | G |

1.2.1.3 Remove AttributeSet
To remove an AttributeSet, the caller should change the timespans of adjacent AttributeSets, or insert a new AttributeSet in place of the one being removed. The caller should also specify to allow for overwrites when changing the timespans of the adjacent AttributeSets.
1.2.1.4 Change AttributeSet Timespan
The timespan of an AttributeSet will be changed when the chg_effective_date or chg_end_date values are modified. When the change dates are modified, the adjacent AttributeSets are automatically adjusted. The caller may specify whether to allow for removals of AttributeSets, in the situation where the timespan change will effectively outdate one or more AttributeSet.
The chg_effective_date of the first AttributeSet of the TemporalView may not be modified. In this case, the TemporalView lifespan should be modified.
The chg_end_date of the last AttributeSet of the TemporalView may not be modified. In this case, the TemporalView lifespan should be modified.
Interface:

TemporalView class:

/**
Calls AftributeSet.changeTimespan( ), and adjusts adjacent
AttributeSets as
appropriate, and overwrites AttributeSets as appropriate.
@param as AttributeSet object being being changed
@param overwrite boolean true if other (adjacent) AttributeSets within
this
TemporalView may be overwritten.
@param correction_mode true if this change should be
considered a correction.
Default is false
@return void
@throws ENExcepfion if the change of dates are not legal within
TemporalView
lifespan
*/
public void changeTimespan(AttributeSet as, UTTimestamp
chg_effective_date,
UTTimestamp chg_end_date, boolean overwrite);
public void changeTimespan(AttributeSet as, UTTimestamp
chg_effecfive_date,
UTTimestamp chg_end_date, boolean overwrite, boolean
correction_mode);
AttributeSet class:
/**
Adjusts change date timestamps of the AttributeSet.
*/
public void changeTimespan(UTTimestamp
chg_effective_date UTTimestamp
chg_end_date);

### Example 1

### Change AttributeSet Timespan (Overlap)

The following AttributeSets exists for Rachel's PERSON entity.

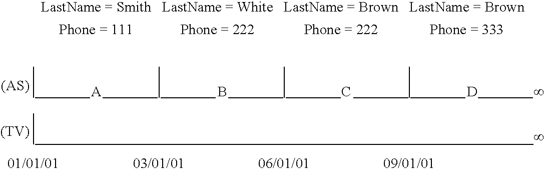

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 1, 2001 | ∞ | Jan. 1, 2001 | Sep. 28, 2001 | F | A |
| 27 | White | 222 | Jan. 1, 2001 | ∞ | Mar. 1, 2001 | May 31, 2001 | F | B |
| 27 | Brown | 222 | Jan. 1, 2001 | ∞ | Jun. 1, 2001 | Aug. 31, 2001 | F | C |
| 27 | Brown | 333 | Jan. 1, 2001 | ∞ | Sep. 1, 2001 | ∞ | F | D |

Rachel expands the AttributeSet for record B until 07/31/01. Records B and C will be updated to become historical records, and records E and F are created to replace them with the modified change dates.

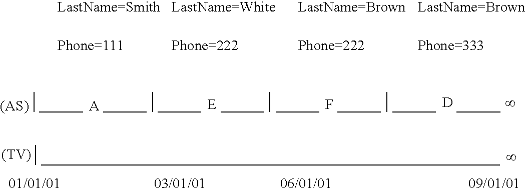

Workflow Records

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 01, 2001 | ∞ | Jan. 01, 2001 | Feb. 28, 2001 | F | A |
| 27 | White | 222 | Jan. 01, 2001 | ∞ | Mar. 01, 2001 | May 31, 2001 | F | B |
| 27 | Brown | 222 | Jan. 01, 2001 | ∞ | Jun. 01, 2001 | Aug. 31, 2001 | F | C |
| 27 | Brown | 333 | Jan. 01, 2001 | ∞ | Sep. 01, 2001 | ∞ | F | D |
| 27 | White | 222 | Jan. 01, 2001 | ∞ | Mar. 01, 2001 | Jul. 31, 2001 | S | E′ |
| 27 | Brown | 222 | Jan. 01, 2001 | ∞ | Aug. 01, 2001 | Aug. 31, 2001 | S | F′ |

ATTR_WF_RECORDS

| RecordID | WFRecordID | IsCorrection |
|---|---|---|
| B | E′ | N |
| C | F′ | N |

Finalized Records w/in Workflow

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 01, 2001 | ∞ | Jan. 01, 2001 | Feb. 28, 2001 | F | A |
| 27 | White | 222 | Jan. 01, 2001 | ∞ | Mar. 01, 2001 | May 31, 2001 | [symbol] H | B |
| 27 | Brown | 222 | Jan. 01, 2001 | ∞ | Jun. 01, 2001 | Aug. 31, 2001 | [symbol] H | C |
| 27 | Brown | 333 | Jan. 01, 2001 | ∞ | Sep. 01, 2001 | ∞ | F | D |
| 27 | White | 222 | Jan. 01, 2001 | ∞ | Mar. 01, 2001 | Jul. 31, 2001 | [symbol] INV | E′ |
| 27 | Brown | 222 | Jan. 01, 2001 | ∞ | Aug. 01, 2001 | Aug. 31, 2001 | [symbol] INV | F′ |
| 27 | White | 222 | Jan. 01, 2001 | ∞ | Mar. 01, 2001 | Jul. 31, 2001 | F | E |
| 27 | Brown | 222 | Jan. 01, 2001 | ∞ | Aug. 01, 2001 | Aug. 31, 2001 | F | F |

Finalized Records w/o Workflow

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 01, 2001 | ∞ | Jan. 01, 2001 | Feb. 28, 2001 | F | A |
| 27 | White | 222 | Jan. 01, 2001 | ∞ | Mar. 01, 2001 | May 31, 2001 | [symbol] H | B |
| 27 | Brown | 222 | Jan. 01, 2001 | ∞ | Jun. 01, 2001 | Aug. 31, 2001 | [symbol] H | C |
| 27 | Brown | 333 | Jan. 01, 2001 | ∞ | Sep. 01, 2001 | ∞ | F | D |
| 27 | White | 222 | Jan. 01, 2001 | ∞ | Mar. 01, 2001 | Jul. 31, 2001 | F | E |
| 27 | Brown | 222 | Jan. 01, 2001 | ∞ | Aug. 01, 2001 | Aug. 31, 2001 | F | F |

### Example 2

### Change AttributeSet Timespan (Overwrite)—with Correction

The following records exist for Rachel's PERSON entity.

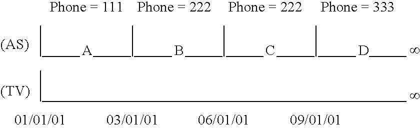

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 1, 2001 | ∞ | Jan. 1, 2001 | Feb. 28, 2001 | F | A |
| 27 | White | 222 | Jan. 1, 2001 | ∞ | Mar. 1, 2001 | May 31, 2001 | F | B |
| 27 | Brown | 222 | Jan. 1, 2001 | ∞ | Jun. 1, 2001 | Aug. 31, 2001 | F | C |
| 27 | Brown | 333 | Jan. 1, 2001 | ∞ | Sep. 1, 2001 | ∞ | F | D |

Rachel expands record C starting from 02/01/01, setting correction mode to true. She specifies to allow for overwrites, so record B is overwritten by this expansion. Records A, B, and C become historical records. Records E and F are created with the modified change dates to represent the shrunk record A and the expanded record C.

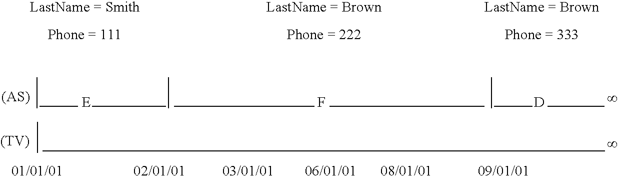

Workflow Records

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 01, 2001 | ∞ | Jan. 01, 2001 | Feb. 28, 2001 | F | A |
| 27 | White | 222 | Jan. 01, 2001 | ∞ | Mar. 01, 2001 | May 31, 2001 | F | B |
| 27 | Brown | 222 | Jan. 01, 2001 | ∞ | Jun. 01, 2001 | Aug. 31, 2001 | F | C |
| 27 | Brown | 333 | Jan. 01, 2001 | ∞ | Sep. 01, 2001 | ∞ | F | D |
| 27 | Smith | 111 | Jan. 01, 2001 | ∞ | Jan. 01, 2001 | Jan. 31, 2001 | S | E′ |
| 27 | Brown | 222 | Jan. 01, 2001 | ∞ | Feb. 01, 2001 | Aug. 31, 2001 | S | F′ |

ATTR_WF_RECORDS

| RecordID | WFRecordID | IsCorrection |
|---|---|---|
| A | E′ | Y |
| C | F′ | Y |
| B | −1 | Y |

Finalized Records w/in Workflow

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 01, 2001 | ∞ | Jan. 01, 2001 | Feb. 28, 2001 | [symbol] R | A |
| 27 | White | 222 | Jan. 01, 2001 | ∞ | Mar. 01, 2001 | May 31, 2001 | [symbol] R | B |
| 27 | Brown | 222 | Jan. 01, 2001 | ∞ | Jun. 01, 2001 | Aug. 31, 2001 | [symbol] R | C |
| 27 | Brown | 333 | Jan. 01, 2001 | ∞ | Sep. 01, 2001 | ∞ | F | D |
| 27 | Smith | 111 | Jan. 01, 2001 | ∞ | Jan. 01, 2001 | Jan. 31, 2001 | [symbol] INV | E′ |
| 27 | Brown | 222 | Jan. 01, 2001 | ∞ | Feb. 01, 2001 | Aug. 31, 2001 | [symbol] INV | F′ |
| 27 | Smith | 111 | Jan. 01, 2001 | ∞ | Jan. 01, 2001 | Jan. 31, 2001 | F | E |
| 27 | Brown | 222 | Jan. 01, 2001 | ∞ | Feb. 01, 2001 | Aug. 31, 2001 | F | F |

Finalized Records w/o Workflow

| | Last | | | End | ChgEff | ChgEnd | Record | Record |
|---|---|---|---|---|---|---|---|---|
| ID | Name | Phone | EffDate | Date | Date | Date | Status | ID |
| 27 | Smith | 111 | Jan. 01, 2001 | ∞ | Jan. 01, 2001 | Feb. 28, 2001 | [symbol] R | A |
| 27 | White | 222 | Jan. 01, 2001 | ∞ | Mar. 01, 2001 | May 31, 2001 | [symbol] R | B |
| 27 | Brown | 222 | Jan. 01, 2001 | ∞ | Jun. 01, 2001 | Aug. 31, 2001 | [symbol] R | C |
| 27 | Brown | 333 | Jan. 01, 2001 | ∞ | Sep. 01, 2001 | ∞ | F | D |
| 27 | Smith | 111 | Jan. 01, 2001 | ∞ | Jan. 01, 2001 | Jan. 31, 2001 | F | E |
| 27 | Brown | 222 | Jan. 01, 2001 | ∞ | Feb. 01, 2001 | Aug. 31, 2001 | F | F |

### 1.2.2 TemporalView

TemporalViews maintain a lifespan of a Date Relational object. A Date Relational object may have more than one TemporalView, or disjoint lifespans. Every TemporalView should have at least one AttributeSet within its lifespan. The lifespan of a TemporalView is determined by the EFFECTIVE_DATE and END_DATE fields.

A TemporalView is created by one of the following two methods:

1. DRBase loadObject method builds one or more TemporalViews from data base records.
2. DRBase addTemporalView method creates a TemporalView containing only effective and end dates.
   1.2.2.1 Add TemporalView
   When adding a TemporalView, the caller creates a new TemporalView by specifying the effective_date and end_date. When a new TemporalView is created, an associated AttributeSet is automatically created, and the caller should set the values of all required attributes, and any optional attributes.
   Interface:

ENDRBaseObject class:

/**
Add a new TemporalView object for this Date Relational
object. An associated
AttibuteSet will also be created.
@return TemporalView newly created TemporalView object
@throws ENException if the dates overlap an already existing Temporal
View
*/
public Temporal View addTemporalView(UTTimestamp
effecfive_date UTTimestamp
end_date);

### Example 1

### Add TemporalView (Simple)

A organization entity exists in the system from 01/01/01 until 05/01/01. From 01/01/01 until 02/28/01, the name of the team is Bagels. From 03/01/01 until 05/01/01, the name of the team is Donuts.

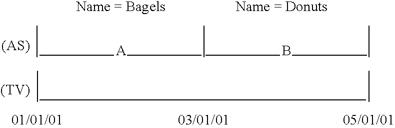

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 1, 2001 | May 1, 2001 | Jan. 1, 2001 | Feb. 28, 2001 | F | A |
| ORG1 | Donuts | Jan. 1, 2001 | May 1, 2001 | Mar. 1, 2001 | May 1, 2001 | F | B |

A new organization lifespan in added to the system, effective 08/01/01 until 12/31/01. The name is Coffee.

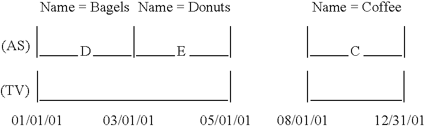

Workflow Records

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan. 01, 2001 | Feb. 28, 2001 | F | A |
| ORG1 | Donuts | Jan. 01, 2001 | May 01, 2001 | Mar. 01, 2001 | May 01, 2001 | F | B |
| ORG1 | Coffee | Aug. 01, 2001 | Dec. 31, 2001 | Aug. 01, 2001 | Dec. 31, 2001 | S | C′ |

ATTR_WF_RECORDS

| RecordlD | WFRecordID | IsCorrection |
|---|---|---|
| −1 | C′ | N |

Finalized Records w/in Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan. 01, 2001 | Feb. 28, 2001 | F | A |
| ORG1 | Donuts | Jan. 01, 2001 | May 01, 2001 | Mar. 01, 2001 | May 01, 2001 | F | B |
| ORG1 | Coffee | Aug. 01, 2001 | Dec. 31, 2001 | Aug. 01, 2001 | Dec. 31, 2001 | [symbol] INV | C′ |
| ORG1 | Coffee | Aug. 01, 2001 | Dec. 31, 2001 | Aug. 01, 2001 | Dec. 31, 2001 | F | C |

Finalized Records w/o Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan. 01, 2001 | Feb. 28, 2001 | F | A |
| ORG1 | Donuts | Jan. 01, 2001 | May 01, 2001 | Mar. 01, 2001 | May 01, 2001 | F | B |
| ORG1 | Coffee | Aug. 01, 2001 | Dec. 31, 2001 | Aug. 01, 2001 | Dec. 31, 2001 | F | C |

1.2.2.2 Remove TemporalView
When a TemporalView is removed, all associated AttributeSets become historical records in the system.
Interface:

TemporalView class:

/**
Removes Temporal View and all associated AttributeSets from the system.
@param correction_mode true if this removal should be considered a
correction.
Default is false
*/
public void remove( );
public void remove(boolean correction_mode);

### Example 1

### Remove TemporalView (Simple)

A organization entity exists in the system from 01/01/01 until 05/01/01. From 01/01/01 until 02/28/01, the name of the team is Bagels. From 03/01/01 until 05/01/01, the name of the team is Donuts.

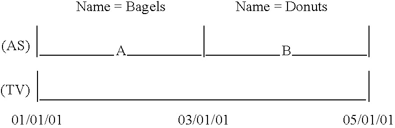

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 1, 2001 | May 1, 2001 | Jan. 1, 2001 | Feb. 28, 2001 | F | A |
| ORG1 | Donuts | Jan. 1, 2001 | May 1, 2001 | Mar. 1, 2001 | May 1, 2001 | F | B |

The organization is removed. Records A and B become historical records.

Workflow Records

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan 01, 2001 | Feb. 28, 2001 | F | A |
| ORG1 | Donuts | Jan. 01, 2001 | May 01, 2001 | Mar. 01, 2001 | May 01, 2001 | F | B |
| ORG1 | Bagels | Jan. 01, 2001 | May 01, 2001 | Jan. 01, 2001 | Feb. 28, 2001 | SD | C |
| ORG1 | Donuts | Jan. 01, 2001 | May 01, 2001 | Mar. 01, 2001 | May 01, 2001 | SD | D |

ATTR_WF_RECORDS

| RecordID | WFRecordID | IsCorrection |
|---|---|---|
| A | −1 | N |
| B | −1 | N |

Finalized Records w/in Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan. 01, 2001 | Feb. 28, 2001 | [symbol] H | A |
| ORG1 | Donuts | Jan. 01, 2001 | May 01, 2001 | Mar. 01, 2001 | May 01, 2001 | [symbol] H | B |
| ORG1 | Bagels | Jan. 01, 2001 | May 01, 2001 | Jan. 01, 2001 | Feb. 28, 2001 | [symbol] | C |
| | | | | | | INV | |
| ORG1 | Donuts | Jan. 01, 2001 | May 01, 2001 | Mar. 01, 2001 | May 01, 2001 | [symbol] | D |
| | | | | | | INV | |

Finalized Records w/o Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan. 01, 2001 | Feb. 28, 2001 | [symbol] H | A |
| ORG1 | Donuts | Jan. 01, 2001 | May 01, 2001 | Mar. 01, 2001 | May 01, 2001 | [symbol] H | B |

1.2.2.3 Change TemporalView Lifespan
A TemporalView will change its lifespan when the effective_date and/or end_date values are modified. The following rules apply when changing the lifespan of a TemporalView:
1. A TemporalView may not change its lifespan to overlap with another TemporalView of this object.
2. The effective_date and end_date of all AttributeSets within the TemporalView will be changed.
3. If the effective_date of the lifespan is modified, the chg_effective_date of the first AttributeSet will be modified. If the end_date of the lifespan is modified, the chg_end_date of the last AttributeSet will be modified.
4. The caller may specify whether to allow for removals of AttributeSets, in the situation where the lifespan change will effectively outdate one or more AttributeSet.
5. If the lifespan is completely moved in time (no overlaps with the original lifespan), the AttributeSet that was effective closest in time to the new lifespan will be in effect for the entire lifespan of the new TemporalView. For example, if the TemporalView is completely moved to a later lifespan, the last AttributeSet in the original lifespan will be used to define the AttributeSet of the new lifespan. If the TemporalView is completely moved to an earlier lifespan, the first AttributeSet in the original lifespan will be used to define the AttributeSet of the new lifespan.
   Interface:

ENDRBaseObject class:

/**
Calls TemporalView.changeLifespan( ). Ensures that the change
in lifespan will not
overlap with another existing TemporalView for this DR object.
@throws ENException if the lifespan change will overlap with
another existing
Temporal View.
*/
public void changeLifespan(TemporalView tv, UTTimestamp
effective_date,
UTTimestamp end_date boolean overwrite);
public void changeLifespan(TemporalView tv, UTTimestamp
effective_date,
UTTimestamp end_date boolean overwrite, boolean correction_mode);

TemporalView class:

/**
Modify the effective and/or end dates of this Temporal View.
@throws ENException if the lifespan is changed so that the
TemporalView will
overlap with another existing Temporal View.
*/
public void changeLifespan(UTTimestamp effective_date,
UTTimestamp end_date,
boolean overwrite, boolean correction_mode);

### Example 1

### Change TemporalView Lifespan (Simple)—with Correction

An organization entity with two TemporalViews exists as below.

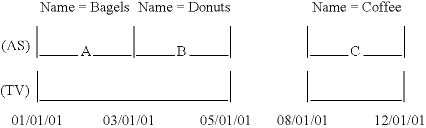

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 1, 2001 | May 1, 2001 | Jan. 1, 2001 | Feb. 28, 2001 | F | A |
| ORG1 | Donuts | Jan. 1, 2001 | May 1, 2001 | Mar. 1, 2001 | May 1, 2001 | F | B |
| ORG1 | Coffee | Aug. 1, 2001 | Dec. 31, 2001 | Aug. 1, 2001 | Dec. 31, 2001 | F | C |

The TemporalView with lifespan 01/01/01 to 05/01/01 is expanded until 07/01/01, with correction mode set to true. The records A and B become historical records, and the records D and E are created to indicate the modified end_date, as well as the modified chg_end_date for record E.

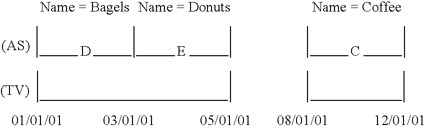

Workflow Records

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan. 01, 2001 | Feb. 28, 2001 | F | A |
| ORG1 | Donuts | Jan. 01, 2001 | May 01, 2001 | Mar. 01, 2001 | May 01, 2001 | F | B |
| ORG1 | Coffee | Aug. 01, 2001 | Dec. 31, 2001 | Aug. 01, 2001 | Dec. 31, 2001 | F | C |
| ORG1 | Bagels | Jan. 01, 2001 | Jun. 30, 2001 | Jan. 01, 2001 | Feb. 28, 2001 | S | D′ |
| ORG1 | Donuts | Jan. 01, 2001 | Jun. 30, 2001 | Mar. 01, 2001 | Jun. 30, 2001 | S | E′ |

ATTR_WF_RECORDS

| RecordID | WFRecordID | IsCorrection |
|---|---|---|
| A | D′ | Y |
| B | E′ | Y |

Finalized Records w/in Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan. 01, 2001 | Feb. 28, 2001 | [symbol] R | A |
| ORG1 | Donuts | Jan. 01, 2001 | May 01, 2001 | Mar. 01, 2001 | May 01, 2001 | [symbol] R | B |
| ORG1 | Coffee | Aug. 01, 2001 | Dec. 31, 2001 | Aug. 01, 2001 | Dec. 31, 2001 | F | C |
| ORG1 | Bagels | Jan. 01, 2001 | Jun. 30, 2001 | Jan. 01, 2001 | Feb. 28, 2001 | [symbol] INV | D′ |
| ORG1 | Donuts | Jan. 01, 2001 | Jun. 30, 2001 | Mar. 01, 2001 | Jun. 30, 2001 | [symbol] INV | E′ |
| ORG1 | Bagels | Jan. 01, 2001 | Jun. 30, 2001 | Jan. 01, 2001 | Feb. 28, 2001 | F | D |
| ORG1 | Donuts | Jan. 01, 2001 | Jun. 30, 2001 | Mar. 01, 2001 | Jun. 30, 2001 | F | E |

Finalized Records w/o Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | May 01, 2001 | Jan. 01, 2001 | Feb. 28, 2001 | [symbol] R | A |
| ORG1 | Donuts | Jan. 01, 2001 | May 01, 2001 | Mar. 01, 2001 | May 01, 2001 | [symbol] R | B |
| ORG1 | Coffee | Aug. 01, 2001 | Dec. 31, 2001 | Aug. 01, 2001 | Dec. 31, 2001 | F | C |
| ORG1 | Bagels | Jan. 01, 2001 | Jun. 30, 2001 | Jan. 01, 2001 | Feb. 28, 2001 | F | D |
| ORG1 | Donuts | Jan. 01, 2001 | Jun. 30, 2001 | Mar. 01, 2001 | Jun. 30, 2001 | F | E |

### Example 2

### Change TemporalView Lifespan (Overwrite)

An organization entity with one TemporalView exists as below.

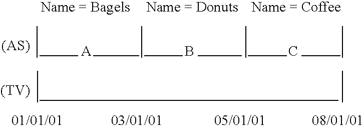

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 1, 2001 | Aug. 1, 2001 | Jan. 1, 2001 | Feb. 28, 2001 | F | A |
| ORG1 | Donuts | Jan. 1, 2001 | Aug. 1, 2001 | Mar. 1, 2001 | Apr. 31, 2001 | F | B |
| ORG1 | Coffee | Jan. 1, 2001 | Aug. 1, 2001 | May 1, 2001 | Aug. 1, 2001 | F | C |

The TemporalView lifespan is modified to end on 04/15/01. The caller specifies that AttributeSets may be overwritten with this transaction.

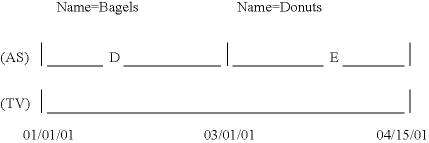

Workflow Records

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | Aug. 01, 2001 | Jan. 01, 2001 | Feb. 28, 2001 | F | A |
| ORG1 | Donuts | Jan. 01, 2001 | Aug. 01, 2001 | Mar. 01, 2001 | Apr. 31, 2001 | F | B |
| ORG1 | Coffee | Jan. 01, 2001 | Aug. 01, 2001 | May 01, 2001 | Aug. 01, 2001 | F | C |
| ORG1 | Bagels | Jan. 01, 2001 | Apr. 15, 2001 | Jan. 01, 2001 | Feb. 28, 2001 | S | D′ |
| ORG1 | Donuts | Jan. 01, 2001 | Apr. 15, 2001 | Mar. 01, 2001 | Apr. 15, 2001 | S | E′ |

ATTR_WF_RECORDS

| RecordID | WFRecordID | IsCorrection |
|---|---|---|
| A | D′ | N |
| B | E′ | N |
| C | −1 | N |

Finalized Records w/in Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | Aug. 01, 2001 | Jan. 01, 2001 | Feb. 28, 2001 | [symbol] H | A |
| ORG1 | Donuts | Jan. 01, 2001 | Aug. 01, 2001 | Mar. 01, 2001 | Apr. 31, 2001 | [symbol] H | B |
| ORG1 | Coffee | Jan. 01, 2001 | Aug. 01, 2001 | May 01, 2001 | Aug. 01, 2001 | [symbol] H | C |
| ORG1 | Bagels | Jan. 01, 2001 | Apr. 15, 2001 | Jan. 01, 2001 | Feb. 28, 2001 | [symbol] INV | D′ |
| ORG1 | Donuts | Jan. 01, 2001 | Apr. 15, 2001 | Mar. 01, 2001 | Apr. 15, 2001 | [symbol] INV | E′ |
| ORG1 | Bagels | Jan. 01, 2001 | Apr. 15, 2001 | Jan. 01, 2001 | Feb. 28, 2001 | F | D |
| ORG1 | Donuts | Jan. 01, 2001 | Apr. 15, 2001 | Mar. 01, 2001 | Apr. 15, 2001 | F | E |

Finalized Records w/o Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | Aug. 01, 2001 | Jan. 01, 2001 | Feb. 28, 2001 | [symbol] H | A |
| ORG1 | Donuts | Jan. 01, 2001 | Aug. 01, 2001 | Mar. 01, 2001 | Apr. 31, 2001 | [symbol] H | B |
| ORG1 | Coffee | Jan. 01, 2001 | Aug. 01, 2001 | May 01, 2001 | Aug. 01, 2001 | [symbol] H | C |
| ORG1 | Bagels | Jan. 01, 2001 | Apr. 15, 2001 | Jan. 01, 2001 | Feb. 28, 2001 | F | D |
| ORG1 | Donuts | Jan. 01, 2001 | Apr. 15, 2001 | Mar. 01, 2001 | Apr. 15, 2001 | F | E |

### Example 3

### Change TemporalView Lifespan (Move to Later Date)

An organization entity with one TemporalView exists as below.

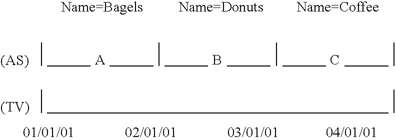

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 1, 2001 | Mar. 31, 2001 | Jan. 1, 2001 | Jan. 31, 2001 | F | A |
| ORG1 | Donuts | Jan. 1, 2001 | Mar. 31, 2001 | Feb. 1, 2001 | Feb. 28, 2001 | F | B |
| ORG1 | Coffee | Jan. 1, 2001 | Mar. 31, 2001 | Mar. 1, 2001 | Mar. 31, 2001 | F | C |

The TemporalView lifespan is completely moved to another lifespan, from 05/01/01 until 07/31/01. The caller specifies that AttributeSets may be overwritten with this transaction.

The Temporal View will now only have one AttributeSet (inherited from record C).

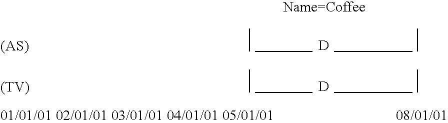

Workflow Records

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | Mar. 31, 2001 | Jan. 01, 2001 | Jan. 31, 2001 | F | A |
| ORG1 | Donuts | Jan. 01, 2001 | Mar. 31, 2001 | Feb. 01, 2001 | Feb. 28, 2001 | F | B |
| ORG1 | Coffee | Jan. 01, 2001 | Mar. 31, 2001 | Mar. 01, 2001 | Mar. 31, 2001 | F | C |
| ORG1 | Coffee | May 01, 2001 | Jul. 31, 2001 | May 01, 2001 | Jul. 31, 2001 | S | D′ |

ATTR_WF_RECORDS

| RecordID | WFRecordID | IsCorrection |
|---|---|---|
| A | −1 | N |
| B | −1 | N |
| C | D | N |

Finalized Records w/in Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | Mar. 31, 2001 | Jan. 01, 2001 | Jan. 31, 2001 | [symbol] H | A |
| ORG1 | Donuts | Jan. 01, 2001 | Mar. 31, 2001 | Feb. 01, 2001 | Feb. 28, 2001 | [symbol] H | B |
| ORG1 | Coffee | Jan. 01, 2001 | Mar. 31, 2001 | Mar. 01, 2001 | Mar. 31, 2001 | [symbol] H | C |
| ORG1 | Coffee | May 01, 2001 | Jul. 31, 2001 | May 01, 2001 | Jul. 31, 2001 | [symbol] INV | D′ |
| ORG1 | Coffee | May 01, 2001 | Jul. 31, 2001 | May 01, 2001 | Jul. 31, 2001 | F | D |

Finalized Records w/o Workflow

| | | | | ChgEff | ChgEnd | Record | Record |
|---|---|---|---|---|---|---|---|
| ID | Name | EffDate | EndDate | Date | Date | Status | ID |
| ORG1 | Bagels | Jan. 01, 2001 | Mar. 31, 2001 | Jan. 01, 2001 | Jan. 31, 2001 | [symbol] H | A |
| ORG1 | Donuts | Jan. 01, 2001 | Mar. 31, 2001 | Feb. 01, 2001 | Feb. 28, 2001 | [symbol] H | B |
| ORG1 | Coffee | Jan. 01, 2001 | Mar. 31, 2001 | Mar. 01, 2001 | Mar. 31, 2001 | [symbol] H | C |
| ORG1 | Coffee | May 05, 2001 | Jul. 31, 2001 | May 01, 2001 | Jul. 31, 2001 | F | D |

1.3 Locking

### 1.3.1 Overview

An XRM object is locked in whole, i.e., all valid lifespans (TemporalViews) of the object are locked. XRM objects are optimistically locked immediately when retrieved from database.

With optimistic locking, you write your program under the assumption that any commit has a chance to fail on account of at least one the objects being committed was changed by someone else since you began the transaction.

Optimistic locking offers reduced concurrency and higher performance than pessimistic locking. It also avoids deadlocks.

When modifications are finalized to the database, XRM objects are pessimistically locked to avoid another thread from accessing the locks during finalization of data.

### 1.3.2 Database Tables

TABLE 1
ENTITY_LOCK

| | | Is | |
|---|---|---|---|
| Field Name | Type | NULL | Description |
| OBJECT_KEY | RAW(1024) | No | The PrimaryKey of the object. |
| TIMESTAMP | DATE | No | The timestamp of the last |
| | | | update to this object's |
| | | | data. |

TABLE 2
ENTITY_WORK_LOCK

| | | Is | |
|---|---|---|---|
| Field Name | Type | NULL | Description |
| WORK_ID | NUMBER(30) | No | The work_id of the |
| | | | user of the object. |
| OBJECT_KEY | RAW(1024) | No | The PrimaryKey of the |
| | | | object. |
| TIMESTAMP | DATE | No | The timestamp of the lock |
| | | | (from the ENTITY_LOCK |
| | | | table) |

### 1.3.3 Locking Procedure

1.3.3.1 Acquiring a Lock

A work process, defined by WORK_ID 1, acquires a lock for the XRM object defined by PK1:

If a lock exists in ENTITY_WORK_LOCK for WORK_ID 1, then that lock is acquired. It indicates that WORK_ID 1 has already locked that entity previously in the workflow. A check can be done on timestamps and an exception thrown if the lock is out of synch.
If a lock does not exist in ENTITY_WORK_LOCK, but does exists in ENTITY_LOCK for the object, then a row is inserted into ENTITY_WORK_LOCK with the timestamp found in ENTITY_LOCK. This indicates that WORK_ID 1 has acquired the lock with that timestamp. For this transaction, a “select for update” is performed on ENTITY_LOCK. This will ensure that if another thread is updating the lock timestamp, then WORK_ID 1 will wait to read the timestamp for that object lock.
If lock does not exist in either ENTITY_LOCK or ENTITY_WORK_LOCK for this object and work process, a row is inserted into ENTITY_LOCK for this object with the current timestamp, and a row is also inserted into the ENTITY_WORK_LOCK table with the same timestamp and with this work_id.
   The database session for the locking transaction is a separate connection from the session used for retrieving the XRM object data. The connection for the locking transaction is in ‘AUTOCOMMIT’ mode to ensure the lock is visible to other threads immediately. The lock should be created BEFORE retrieving the XRM object from the database, as it will ensure data integrity. (If the lock were acquired AFTER retrieving the XRM entity from the database, there would be a race condition between the time of retrieval and the time the lock is acquired—another thread may have finalized the same XRM entity, and updated it's lock during that time.)
   1.3.3.2 Asserting the Lock
   WORK_ID 1 modifies PK1 data, and is ready to finalize. It does a “select for update” on the ENTITY_LOCK table for the PK1 lock. It compares the timestamp found in the ENTITY_LOCK table with the lock in has acquired from the ENTITY_WORK_LOCK table.
   If the timestamps match, then WORK_ID 1 updates the ENTITY_LOCK table with the current system time. Then, it finalizes the XRM data to the database. If the timestamps do not match, then the locks are out of synch and data integrity is no longer valid. An exception is thrown.
   The transactions in this step are all performed within the same database session, and the changes are not committed to the database until the end of the transaction. This will ensure that another thread will not read the ENTITY_LOCK timestamp until the XRM object changes made by WORK_ID 1 have been finalized to the database.

### 1.3.4 Examples

### Example 1

WORK_ID 1 acquires a lock for XRM object defined by PK1. A row is inserted into ENTITY_LOCK, with the current timestamp of 09:00:00. A row is also inserted into the ENTITY_WORK_LOCK table, with the same timestamp. The inserts are committed immediately to the database.

| | |
|---|---|
| ENTITY_LOCK | ENTITY_WORK_LOCK |

| ObjectKey | Timestamp | WorkID | ObjectKey | Timestamp |
|---|---|---|---|---|
| PK1 | 09:00:00 | 1 | PK1 | 09:00:00 |

1. WORK_ID 2 acquires a lock for PK1. It sees the entry in ENTITY_LOCK, and inserts a row into ENTITY_WORK_LOCK, with the timestamp of 09:00:00, since that is the lock timestamp.

| | |
|---|---|
| ENTITY_LOCK | ENTITY_WORK_LOCK |

| ObjectKey | Timestamp | WorkID | ObjectKey | Timestamp |
|---|---|---|---|---|
| PK1 | 09:00:00 | 1 | PK1 | 09:00:00 |
| | | 2 | PK1 | 09:00:00 |

2. WORK_ID 2 modifies PK1 records, and attempts to finalize its changes. It performs a “select for update” on the ENTITY_LOCK for PK1, and compares its timestamp to the one for ENTITY_WORK_LOCK. Since they match, the PK1 records are finalized, the ENTITY_WORK_LOCK removed for WORK_ID 2, and the ENTITY_LOCK record updated to reflect the current system time of 10:00:00. All database changes are done in the same transaction as the “select for update”, which means the ENTITY_LOCK row for PK1 has been pessimistically locked during the entire transaction.
3. Meanwhile (before WORK_ID 2 has completed the finalization), WORK_ID 3 tries to acquire a lock for PK1. It performs a “select for update” on the ENTITY_LOCK record, and has to wait, because WORK_ID1 still has that record locked in the database.

4. WORK_ID 2 completes successfully.

| | |
|---|---|
| ENTITY_LOCK | ENTITY_WORK_LOCK |

| ObjectKey | Timestamp | WorkID | ObjectKey | Timestamp |
|---|---|---|---|---|
| PK1 | 10:00:00 | 1 | PK1 | 09:00:00 |

5. WORK_ID 3 no longer has to wait, it now performs a “select for update” on the ENTITY_LOC record, finds the timestamp of 10:00:00, and uses that timestamp to insert a row into ENTITY_WORK_LOCK for itself.

| | |
|---|---|
| ENTITY_LOCK | ENTITY_WORK_LOCK |

| ObjectKey | Timestamp | WorkID | ObjectKey | Timestamp |
|---|---|---|---|---|
| PK1 | 10:00:00 | 2 | PK1 | 09:00:00 |
| | | 3 | PK | 10:00:00 |

6. WORK_ID 2 attempts to finalize. It determines that the ENTITY_LOCK timestamp no longer matches the one it has in ENTITY_WORK_LOCK. WORK_ID 2 will fail to finalize.
   1.4 Container-Contained Implementation
   Container-contained infrastructure defines logical joins of objects in XRM. The joins are defines in the container registry Meta Data.

### 1.4.1 Container Registry Sub-Model

TABLE 3
CONTAINER_REGISTRY

| | | |
|---|---|---|
| CONTAINER_REF_NAME | VARCHAR2(2000) | Reference name of the |
| | | outer object |
| CONTAINED_REF_NAME | VARCHAR2(2000) | Reference name of the |
| | | object to join to |
| REFERENCE_NAME | VARCHAR2(40) | Name of this join |
| CONTAINED_AS_COLLECTION | VARCHAR2(10) | Type of the |
| | | containment. Possible |
| | | Values are |
| | | NULL - one-to-one join |
| | | LIST - for one-to-many |
| | | join |

TABLE 4
CONTAINER_REGISTRY_FIELD_MAP

| | | |
|---|---|---|
| CONTAINER_REF_NAME | VARCHAR2(2000) | Reference name |
| | | of the outer object |
| REFERENCE_NAME | VARCHAR2(40) | Name of this join |
| CONTAINER_FIELD_NAME | VARCHAR2(80) | Name of the outer |
| | | object field to |
| | | use for the join |
| CONTAINED_FIELD_NAME | | Name of the |
| | | object field to |
| | | join to |
| USE_NULL | VARCHAR2(1) | If yes a null value |
| | | is acceptable as |
| | | a field |
| | | value of the outer |
| | | object |

### 1.4.2 Implementation

Single object containment is read and stored via standard load procedures of the ENDRBaseObject.

List type containment is stored in the ContainedObjectList and uses lazy instantiation of objects from the CachedRowSet. See class description for details Section 1.6.5 below.

1.5 In-Memory Caches and Optimizations

### 1.5.1 Changed Object Caching

Changed objects need to be cached and easily identifiable and accessible to support re-query by the user. For example, object ENOrg is retrieved, modified. At later point of the application an attempt is made to retrieve that same organization object from the database. It is necessary to determine that object not only has been retrieved already but also has been modified from its original version and to return that modified object as a result to avoid multiple conflicting changes to the same object.

1.5.1.1 Release 2.X Implementation

Each object that is added to the change list is also added to the hash table of modified objected keyed off of record id. When refresh( ) is called on the ENDRBaseObject it first retrieves record id and attempts to look up object in the hash table of modified object. If object is found, it is returned in place of the query result.

Object in Release 3.0 may be represented by more then one actual database record. That makes hashing object by record id impossible and requires re-design as follows

1.5.1.2 Release 3.0 Implementation

The change list is implemented as a TreeMap keyed off of object's key HashMap. When loadObject( ) method is called on ENDRBaseObject it first of all reads logical primary keys of the object. At that point an attempt to find object in the changes list should be made. If object exists in the change list the object from the change list should be returned instead of loading the object from the result set.

1.6 Classes and Interfaces

### 1.6.1 TemporalEngine Class

TemporalEngine class is responsible for:

Reading and interpreting entity metadata

Generating SQL for retrieving and storing objects—package access

Creating new objects

Handling corkboard

Generating unique keys

1.6.1.1 Additional Functionality

TemporalEngine getInstance(IOSESession session);
IOSEObject getObject(String name, UTTimestamp asof);
IOSEObject createObject(String name, UTNameValuePair[]
attributes);
void deleteCorkboard( );
void deleteCorkboard(long work_id);
void deleteCorkboard(String object_name);
void storeInCorkboard(IOSEObject obj);
void storeInCorkboard(IOSEObject obj, String label);
void storeInCorkboard(IOSEObject obj, long work_id, String label);
long generateRecordID( );
String generateUniqueID( );

1.6.1.2 Current Customer Impact
TemporalEngine.getInstance (IOSESession session) method should be called right after session is established and before any other calls are made.

### 1.6.2 IOSEObject

1.6.2.1 Deprecated Functionality

get

1.6.2.2 Removed Functionality

getChangeEffectiveDate
setChangeEffectiveDate
getChangeEndDate
setChangeEndDate
getEffectiveDate
setEffeefiveDate
getEndDate
setEndDate
isClosed
set

1.6.2.3 Additional Functionality

/** retrives full set of temporal view for the object
*/
TemporalView[ ] getTemporalViews( );
/** retrives Tamporal view of the object for a given date;
* returns null if object is not valid on the date specified
*/
Temporal View getTemporalView(UTTimestamp asof);
/** returns true if object is valid on the date specified
*/
boolean isEffective(UTTimetamp date);
/* creates a new TemporalView and adds it to view collection
*/
Temporal View addTemporalView(UTTimestamp effective_date,

UTTimestamp end_date)

void setCurrentViewDate(UTTimestamp asof);
UTTimestamp getCurrentViewDate( );
Object getContained(String refname);

1.6.2.4 Current Customer Impact
Deprecated methods can still be used and will access current view of the object.

### 1.6.3 ENDRBaseObject

java.lang.Object
         |_bnridgestream.en.ENDRBaseObject
All implemented interfaces:
   IOSEObejct
      The ENDRBaseObject class represents basic temporal object. It encapsulates all effective life spans and AttributeSets within those life spans. ENDRBaseObject provides the following functionality:
Provides current, i.e. as of specified date, view of the object including its lifespan and attributes
Maintains optimistic locking
Provides access to collection of valid object life spans (see section 1.6.6 below)
Maintains the container—contained object relationship
Provides methods for object manipulation such as changing existing life spans, adding new life spans in the past or future, validations of any and all life span manipulations, changing attributes, saving, and finalizing object.
   ENDRBaseObject aggregates set of TemporalViews (TemporalView) of the as a LifespanCollection collection. Historical TemporalViews of the object retrieved from database utilize lazy instantiation. New parameter is added to login.properties file
temporal_history=<number of days>
   When object is first retrieved from the database the data that falls within specified number of days before and after as of date retrieved. If later on an attempt is made to access lifespan of the object that falls outside the specified range of dates the data is retrieved on demand.
   1.6.3.1 Deprecated Functionality

See 1.6.2.1 above

getFutureObjects
getFutureContainedObjects
compareAsOfDate
delete
getObject
getList( );
getListSize( );
addListElement( );
removeListElement( );
deleteListeElement( );

1.6.3.2 Additional Functionality
See 1.6.2.3 above
ContainedObject getContainedObject(String ref name);

### 1.6.4 ContainedObject Class

Contained object class represents object or objects defined to be contained by an outer object in container registry. Class has public visibility.

/**
* retrieves type of the containment -
* ContainedObject.Type.SINGLE
* ContainedObject.Type. LIST
*/
ContainedObject.Type getType( )
/**
* retrives single contained object. If type of the containment is not
* ContainedObject.Type.SINGLE - throws ENExcpetion
*/
ENDRBaseObject getObject( );
/**
* retrieves list of contained objects. If typeof the containment is not
* ContainedObject.Type.LIST - throws ENExcepfion
*/
ContainedObjectList getList( );

### 1.6.5 ContainedObjectList Class

The class extends HashMap and stores contained objects keys off of their primary keys for fast access during validations. ContainedObjectList implements lazy object instantiation. Constructor stores reference to the CachedRowSet supplied as an argument. It then proceeds to iterate though the CachedRowSet to construct each contained object. However, for each object only primary logical keys are read and an index of the first record in the CachedRowSet corresponding to the object. If get is called for the object then the full temporal information is loaded from the CachedRowSet.

ContainedObjectList(ChachedRowSet rs);
/** attempts to find and return object in the list by objects keys
* @return object if found or null
*/
ENDRBaseObject get(UTNameValuPair[ ] keys);
/** attempts to find and return object in the list by objects keys
* @return object if found or null
*/
ENDRBaseObject get(HashMap keys);
/** adds new member to the list
* Method will throw an exception if member with the same keys
exists
*/
add(ENDRBaseObject obj);
/** retrieves size of the list
*/
size( );

1.6.6 ILifespan Interface

ILifespan interface provides common interface that represents a lifespan of either object or AttributeSet. The interface has package visibility.

UTTimestamp getStartDate( );
UTTimestamp getEndDate( );
boolean isWithin(UTTimestamp date);

### 1.6.7 TemporalView Class

java.lang.Object
         |_bridgestream.en.TemporalView
All implemented interfaces:
   ILifespan
      TemporalView represents single lifespan period of an object. TemporalView class aggregates a collection of AttributeSet objects as LifespanCollection.

### 1.6.8 AttributeSet Class

Represents a single set of attributes, i.e. record in the database Implements ILifespan

### 1.6.9 LifespanCollection Class

LifespanCollection represents a collection of valid life spans for either object or AttributeSet. The collection is always sorted by time and is optimized for access based on specified date

Methods:

ILifespan get(UTTimestamp as_of) - retrieves valid timeframe the
specified date is in
or null if date does not fall within valid lifespan

ILifespan add( UTTimestamp effective_date UTTimestamp
end_date) -
remove
Expand(....)

Shorten(....)

### 2 Temporal Object Hierarchy

2.1 Object Classification

2.1.1 Object Classification

Effective V3.0 all objects in XRM are date relational. The objects categorized as one of the following:

ENTITY
RELATIONSHIP
INFO
CODE_TABLE
PSEUDO
VIEW

2.1.1.1 Entity

Entity is on object in XRM that is uniquely identified and represented by a single Universal ID-based logical primary key. Entity is a main subject of all inquiries and data manipulations in XRM. OrgStream currently ships with 3 kinds of entities—person, position, and organization.
ENEntity class represents entity in the API. Any custom implementation of an entity should extend ENEntity class.
ENEntity class provides access to the entity ID via method:
ENUniversalID getEntityID( )
   2.1.1.2 Relationship
   Relationship establishes connection between 2 entities. ENRelationship class implements default relationship behavior. When relationship class is manipulated the following additional checks and adjustments are performed:
Effective date is latest of the specified date, effective date of the first and effective date of the second subject
End date is earliest of the specified date, end date of the first and end date of the second subject
   The following methods are provided:
RelationshipType getType( )—retrieves type of the relationship.
ENUniversalID getMainSubjectID( )—retrieves main subject in the relationship.
ENUniversalID getRelatedSubjectID( )—retrieves related subject in the relationship.
   ENRelationship class is an abstract class and cannot be instantiated. It serves as base class for specific relationship classes. Any relationship object in XRM should extend one of the specific relationship classes: SubordinateRelationship, InheritorRelationship, and EqualRelationship.
   2.1.1.2.1 Subordinate Relationship
   Subordinate relationship defines a relationship where one entity is logical part of another entity or is subordinate to another entity. For example, organization member is a subordinate (or part of) his/her organization.
   2.1.1.2.2 Inheritor Relationship
   Inheritor Relationship defines a relationship when subordinate object inherits all properties and relationships of the superior object. An example of such relationship is worker-to-position relationship. Position information adds information about worker. All relationships position occupied by him has applied to the worker.
   2.1.1.2.3 Equal Relationship
   Equal Relationship defines a relationship between 2 equal subjects. In case of equal relationship superior and subordinate identification is assigned arbitrary.
   2.1.1.3 Info
   Informational object is an object in XRM that contain additional information about entities and relationships. InfoObject class implements basic functionality of such object.
   2.1.1.4 Code Tables
   Code table represent code—decode combination. Any class that implements code table object should extend CodeTable class. CodeTable class enforces the following rules:
Code entry lifespan can not ended if code is in use
Code is a primary logical key and cannot be changed.
   2.1.1.5 Pseudo Objects
   Pseudo objects have no physical table behind them and represent code only objects. PseudoObject implements it. PseudoObject class is an abstract class and cannot be instantiated. It serves as base class for specific types of pseudo classes. Any class that represents pseudo object in XRM should extend one of the specific classes: SuperclassObject, DataStoreObject, and SubclassObject.
   2.1.1.5.1 Super Class Object
   2.1.1.5.2 Data Store Object
   2.1.1.5.3 Sub Class Object
   2.1.2 Meta Data Changes
   Meta Data subschema has changed to support object classification. Each category of objects has its own registry.
   2.1.2.1 Deleted Tables
   EN_REGISTRY
   EN_FIELD_REGISTRY

2.1.2.2 Entity Registry Sub-Model

TABLE 5
REGISTRY_ENTITY

| | | | |
|---|---|---|---|
| REFERENCE_NAME | NOT | NULL | VARCHAR2(80) |
| CLASS_NAME | | | VARCHAR2(2000) |
| TABLE_NAME | | | VARCHAR2(80) |

TABLE 6
REGISTRY_ENTITY_FIELDS

| | | | | |
|---|---|---|---|---|
| REFERENCE_NAME | NOT | NULL | VARCHAR2(80) | |
| FIELD_NAME | NOT | NULL | VARCHAR2(2000) | |
| IS_PK | NOT | NULL | VARCHAR2(1) | Y |
| | | | | N |
| IS_UID | NOT | NULL | VARCHAR2(1) | Y |
| | | | | N |

2.1.2.3 Relationship Registry Sub-Model

TABLE 7
REGISTRY_RELATIONSHIP

| | | | |
|---|---|---|---|
| REFERENCE_NAME | NOT | NULL | VARCHAR2(8o) |
| CLASS_NAME | | | VARCHAR2(2000) |
| TABLE_NAME | NOT | NULL | VARCHAR2(80) |
| TYPE | NOT | NULL | VARCHAR2(20) |

TABLE 8
REGISTRY_RELATIONSHIP_FIELDS

| | | | | |
|---|---|---|---|---|
| REFERENCE_NAME | NOT | NULL | VARCHAR2(80) | |
| FIELD_NAME | NOT | NULL | VARCHAR2(2000) | |
| FIELD_USAGE | NOT | NULL | VARCHAR2(12) | SUPERIOR |
| | | | | SUBORDINATE |
| | | | | ATTRIBUTE |
| IS_UID | NOT | NULL | VARCHAR2(1) | Y |
| | | | | N |

TABLE 9
RELATIONSHIP_RESTRICTIONS

| | | |
|---|---|---|
| REFERENCE_NAME | NOT NULL | VARCHAR2(80) |
| FIELD_USAGE | NOT NULL | VARCHAR2(12) |
| ALLOWED_ENTITIES | NOT NULL | VARCHAR2(80) |

Relationship restriction table is used to restrict kind of entities that can participate in the relationship. If relationship does not have entries in the table, the relationship is unrestricted, otherwise only specified entity types are allowed to participate in the relationship in specified capacity. For example, worker-to-position relationship is the most restrictive as shown in the table below:

| REFERENCE_NAME | FIELD_USAGE | ALLOWED_ENTITIES |
|---|---|---|
| WORKER_TO_POS | SUPERIOR | POSITION |
| WORKER_TO_POS | SUBORDINATE | WORKER |

2.1.2.4 Info Registry Sub-Model

TABLE 10
INFO_REGISTRY

| | | | |
|---|---|---|---|
| REFERENCE_NAME | NOT | NULL | VARCHAR2(80) |
| CLASS_NAME | | | VARCHAR2(2000) |
| TABLE_NAME | NOT | NULL | VARCHAR2(80) |

TABLE 11
INFO_FIELD_REGISTRY

| | | | | |
|---|---|---|---|---|
| REFERENCE_NAME | NOT | NULL | VARCHAR2(80) | |
| FIELD_NAME | NOT | NULL | VARCHAR2(2000) | |
| IS_PK | NOT | NULL | VARCHAR2(1) | Y |
| | | | | N |
| IS_UID | NOT | NULL | VARCHAR2(1) | Y |
| | | | | N |

2.1.2.5 Code Registry Sub-Model

TABLE 12
CODE_REGISTRY

| | | | |
|---|---|---|---|
| REFERENCE_NAME | NOT | NULL | VARCHAR2(80) |
| CLASS_NAME | | | VARCHAR2(2000) |
| TABLE_NAME | NOT | NULL | VARCHAR2(80) |

TABLE 13
CODE_FIELD_REGISTRY

| | | | | |
|---|---|---|---|---|
| REFERENCE_NAME | NOT | NULL | VARCHAR2(80) | |
| FIELD_NAME | NOT | NULL | VARCHAR2(2000) | |
| IS_PK | NOT | NULL | VARCHAR2(1) | Y |
| | | | | N |

2.1.2.6 Pseudo Registry Sub-Model

TABLE 14
PSEUDO_CLASS_REGISTRY

| | | | | |
|---|---|---|---|---|
| REFERENCE_NAME | NOT | NULL | VARCHAR2(80) | |
| CLASS_NAME | NOT | NULL | VARCHAR2(2000) | |
| BASE_CLASS | | | VARCHAR2(2000) | |
| TYPE | NOT | NULL | VARCHAR2(12) | SUPERCLASS |
| | | | | SUBCLASS |
| | | | | DATASTORE |

TABLE 15
PSEUDO_FIELD_REGISTRY

| | | | | |
|---|---|---|---|---|
| REFERENCE_NAME | NOT | NULL | VARCHAR2(80) | |
| FIELD_NAME | NOT | NULL | VARCHAR2(2000) | |
| IS_PK | NOT | NULL | VARCHAR2(1) | Y |
| | | | | N |
| IS_UID | NOT | NULL | VARCHAR2(1) | Y |
| | | | | N |

2.1.2.7 Abstract Class Registry Sub-Model

TABLE 16
REGISTRY_ABSTRACT_CLASS

| | | | |
|---|---|---|---|
| REFERENCE_NAME | NOT | NULL | VARCHAR2(80) |
| CLASS_NAME | NOT | NULL | VARCHAR2(2000) |

TABLE 7
REGISTRY_ABSTRACT_CLASS_FIELDS

| | | | | |
|---|---|---|---|---|
| REFERENCE_NAME | NOT | NULL | VARCHAR2(80) | |
| FIELD_NAME | NOT | NULL | VARCHAR2(2000) | |
| IS_PK | NOT | NULL | VARCHAR2(1) | Y |
| | | | | N |
| IS_UID | NOT | NULL | VARCHAR2(1) | Y |
| | | | | N |

TABLE 18
REGISTRY_ABSTRACT_ELEMENT

| | | | |
|---|---|---|---|
| REFERENCE_NAME | NOT | NULL | VARCHAR2(80) |
| ABSTRACT_REF_NAME | NOT | NULL | VARCHAR2(80) |
| BY_FIELD_NAME | NOT | NULL | VARCHAR2(2000) |
| BY_VALUE | | | VARCHAR2(2000) |

2.1.2.8 View Registry Sub-Model

TABLE 19
VIEW_REGISTRY

| | | | |
|---|---|---|---|
| REFERENCE_NAME | NOT | NULL | VARCHAR2(80) |
| CLASS_NAME | NOT | NULL | VARCHAR2(2000) |

TABLE 20
VIEW_FIELD_REGISTRY

| | | | | |
|---|---|---|---|---|
| REFERENCE_NAME | NOT | NULL | VARCHAR2(80) | |
| FIELD_NAME | NOT | NULL | VARCHAR2(2000) | |
| IS_PK | NOT | NULL | VARCHAR2(1) | Y |
| | | | | N |
| IS_UID | NOT | NULL | VARCHAR2(1) | Y |
| | | | | N |

The conversion for existing types follows the rules shown by Table 21:

Table 21 Object Type Conversion

| EN_TYPE | CATEGORY |
|---|---|
| DR | One of the |
| | ENTITY |
| | RELATIONSHIP |
| | INFO |
| TR | CODE_TABLE |
| VIEW | VW |
| PS | PSEUDO |
| SU | PSEUDO |

2.1.3 Container—Contained Changes

Instead of class name, container—contained registry will be using object reference names.

| | | | |
|---|---|---|---|
| CONTAINER_NAME | NOT | NULL | VARCHAR2(80) |
| CONTAINED_NAME | NOT | NULL | VARCHAR2(80) |
| REFERENCE_NAME | NOT | NULL | VARCHAR2(40) |
| CONTAINED_AS_ | | | VARCHAR2(10) |
| COLLECTION | | | |

2.1.4 Coding Changes and Customer Implications
Custom objects should be classified in Entity Registry.
Custom object classes should be derived from appropriate base category classes.

### 3 Additional Meta Data Enhancements

3.1.1 Package information

Effective v3.0 package information is an integral part of the implementing class definition. CLASS_NAME field has been extended to VARCHAR2 (2000) and should contain full class name including its package information. For example, ENPerson class name should be replaced with bridgestream.en.ENPerson, ENWfStep class name should be replaced with bridgestream.workflow.ENWfStep. Field ‘package’ has been removed.

3.1.2 Universal ID Handling Support

Effective v3.0 fields of Universal id type will no longer be determined by field size. Instead new field IS_UID VARCHAR2(1) is added to the registry sub-model.

### Alternative Embodiments

The invention can be embodied in methods of using temporal data, as well as in software and/or hardware such as a computer, network, or other system that implements the methods, and in various other embodiments.

In the preceding description, a preferred embodiment of the invention is described with regard to preferred process steps and data structures. However, those skilled in the art would recognize, after perusal of this application, that embodiments of the invention may be implemented using one or more general purpose processors or special purpose processors adapted to particular process steps and data structures operating under program control, that such process steps and data structures can be embodied as information stored in or transmitted to and from memories (e.g., fixed memories such as DRAMs, SRAMs, hard disks, caches, etc., and removable memories such as floppy disks, CD-ROMs, data tapes, etc.) including instructions executable by such processors (e.g., object code that is directly executable, source code that is executable after compilation, code that is executable through interpretation, etc.), and that implementation of the preferred process steps and data structures described herein using such equipment would not require undue experimentation or further invention.

Furthermore, the invention is in no way limited to the specifics of any particular preferred embodiment disclosed herein. Many variations are possible which remain within the content, scope and spirit of the invention, and these variations would become clear to those skilled in the art after perusal of this application.

1. A database including a set of data objects, each data object being associated with a set of attributes, including:
temporal data specifying a life span for one or more of said attributes, access and modification of an attribute having temporal data for a data object being allowed only during the life span of that attribute, the temporal data allowing for different versions of an attribute with different life spans to be accessible and modifiable only during the different life spans as specified by the temporal data;
wherein each life span is defined by at least one effective date and at least one end date;
wherein the data objects further include temporal views associating the life spans to said objects;
wherein the database stores and manages multiple entries to maintain a record of changes and write data.

2. A database including a set of objects, each object being associated with a set of attributes, each attribute being associated with a set of business rules for use or modification thereof, including
temporal data specifying a life span for one or more of said attributes, access and modification of an attribute having temporal data being allowed only during the life span of that attribute as defined by the set of business rules for that attribute;
wherein each of said life spans is defined by at least one effective date and at least one end date;
wherein said objects further include temporal views associating said life spans to said objects;
wherein the database stores and manages multiple data entries to maintain a record of changes and write data.

3. A database including a set of objects, each object being associated with a set of attributes, each attribute being associated with a set of business rules for use or modification thereof, including
temporal data specifying a life span for one or more of said business rules, application of said business rules allowing access and modification of an associated attribute only during the life span of each business rule;
wherein each of said life spans is defined by at least one effective date and at least one end date;
wherein said objects further include temporal views associating said life spans to said objects;
wherein the database stores and manages multiple data entries to maintain a record of changes and write data.

4. A database including a set of objects, each object being associated with a set of attributes, each attribute being associated with a set of business rules for use or modification thereof, including
temporal data specifying a life span for one or more rights to use or modify that database, access and modification of tee database only being allowed according to one of the rights during the life span of that right;
wherein said objects further include temporal views associating said life spans to said objects;
wherein the database stores and manages multiple data entries to maintain a record of changes and write data;
wherein each of said life spans is specified by au effective date and an end date maintained in said temporal views.

5-6. (canceled)

7. The database as in claims 1, 2, or 3, wherein each of said life spans is specified by an effective date and an end date maintained in said temporal views.

8. The database as in claims 1, 2, 3 or 4, wherein each attribute, business rule or right has associated therewith a change effective date and a change end date.

9. The database as in claim 8, wherein in each temporal view, gaps are prevented between successive life spans for each attribute, business rule or right.

10. The database as in claim 9, wherein gaps are permitted between successive life spans for each temporal view.

11. The database as in claim 1, 2, 3 or 4, wherein said objects include sub-parts, each of which has its own associated life span.

12. The database as in claim 1, 2, 3 or 4, wherein modification of each attribute, business rule or right in a non-atomic process is performed using techniques for maintaining those modifications as provisional until those modifications are committed, whereby consistent modifications can be performed concurrently.

13. The database as in claim 1, 2, 3 or 4, wherein modification of said temporal data in a non-atomic process is performed using techniques for maintaining those modifications as provisional until those modifications are committed, whereby consistent modifications can be performed concurrently.

14. The database as in claim 1, 2, 3 or 4, wherein modification of each attribute, business rule or right in the database causes any updates to be validated against other information maintained by the database.

15. The database as in claim 14, wherein said other information includes said temporal data, whereby each said modification is, checked for consistency with said temporal data.

16. The database as in claim 1, 2, 3 or 4, wherein each process, user or workgroup that attempts to use an object is given an optimistic lock on that object, said optimistic lock being recorded but not preventing other processes, users or workgroups from attempting to use said object.

17. The database as in claim 16, wherein each process, user or workgroup that attempts to commit a change to the object is given a pessimistic lock on that object, said pessimistic lock preventing other processes, users or workgroups from attempting to commit inconsistent changes to said object.

18. The database as in claim 1, 2, 3 or 4, wherein a record of changes to said objects are maintained in said database.

19. The database as in claim 18, wherein temporal data is associated with said changes.

20. A method of maintaining a database including a set of objects, each object being associated with a set of attributes, including steps of
specifying temporal data by user input including a life span for one or more of said attributes, access and modification of an attribute having temporal data for a data object being allowed only during the life span of that attribute, the temporal data allowing for different versions of an attribute with different life spans to be accessible and modifiable only during the different life spans as specified by the temporal data;
defining by the database each life span by at least one effective date and at least one end date;
wherein said objects fixer include temporal views associating said life spans to said objects;
wherein the database stores and manages multiple data entries to maintain a record of changes and write data.

21. A method of maintaining a database including a set of objects, each object being associated with a set of attributes, each attribute being associated with a set of business rules for use or modification thereof, including steps of
specifying temporal data by user input including a life span for one or more of said attributes, access and modification of an attribute having temporal data being allowed only during the life span of that attribute as defined by the set of business rules for that attribute;
defining by the database each of said life spans by at least one effective date and at least one end date;
wherein said objects further include temporal views associating said life spans to said objects;
wherein the database stores and manages multiple data entries to maintain a record of changes and write data.

22. A method of maintaining a database including a set of objects, each object being associated with a set of attributes, each attribute being associated with a set of business rules for use or modification thereof, including steps of
specifying temporal data by user input including a life span for one or more of said business rules, application of said business rules allowing access and modification of an associated attribute only during the life span of each business rule;
defining by the database each of said life spans by at least one effective date and a least one end date;
wherein said objects further include temporal views associating said life spans to said objects;
wherein the database stores and manages multiple data entries to maintain a record of changes and write data.

23. A method of maintaining a database including a set of objects, each object being associated with a set of attributes, each attribute being associated with a set of business rules for use or modification thereof, including steps of
specifying temporal data by user input including a life span for one or more rights to use or modify that database, access and modification of the database only being allowed according to one of the rights during the life span of that right;
wherein each of said life spans is defined by at least one effective date and at least one end date;
wherein said objects further include temporal views associating said life spans to said objects;
wherein the database stores and manages multiple data entries to maintain a record of changes and write data.

24-25. (canceled)

26. The method as in claims 20, 21, 22 or 23, further including steps of specifying said life spans by effective dates and end dates maintained in said temporal views.

27. The method as in claims 20, 21, 22 or 23, wherein each attribute, business rule or right has associated therewith a change effective date and a change end date.

28. The method as in claim 27, further including a step of preventing gaps between successive life spans for each attribute, business rule or right in each temporal view.

29. The method as in claim 28, further including a step of permitting gaps between successive life spans for each temporal view.

30. The method as in claim 20, 21, 22 or 23, wherein said objects include sub-parts, each of which has its own associated life span.

31. The method as in claim 20, 21, 22 or 23, further including steps of modifying each attribute, business rule or right in a non-atomic process that is performed using techniques for maintaining those modifications as provisional until those modifications are committed, whereby consistent modifications can be performed concurrently.

32. The method as in claim 20, 21, 22 or 23, further including steps of modifying said temporal data in a non-atomic process that is performed using techniques for maintaining those modifications as provisional until those modifications are committed, whereby consistent modifications can be performed concurrently.

33. The method as in claim 20, 21, 22 or 23, further including steps of validating modification of each attribute, business rule or right in the database against other information maintained by the database.

34. The method as in claim 33, wherein said other information includes, said temporal data, whereby each said modification is checked for consistency with said temporal data.

35. The method as in claim 20, 21, 22 or 23, further including steps of giving an optimistic lock on an object to each process, user or workgroup attempt to use that object, said optimistic lock being recorded but not preventing other processes, users or workgroups from attempting to use said object.

36. The method as in claim 35, further including steps of giving a pessimistic lock on the object to each process, user or workgroup that attempts to commit a change to that object, said pessimistic lock preventing other processes, users or workgroups from attempting to commit inconsistent changes to said object.

37. The method as in claim 20, 21, 22 or 23, wherein a record of changes to said objects are maintained in said database.

38. The method as in claim 37, wherein temporal data is associated with said changes.
